(19) United States
(12) Patent Application Publication
(10) Pub. No.: US 2022/0118355 A1
(43) Pub. Date: Apr. 21, 2022

(54) FOOTWEAR CONTROLLER FOR AN ELECTRONIC DEVICE AND METHOD OF OPERATING THE SAME

(71) Applicant: SonicSensory, Inc., Los Angeles, CA (US)

(72) Inventors: Thomas Song Moyland, Los Angeles, CA (US); Pratik Sudhir Borole, Los Angeles, CA (US); Daniel Quiros, Los Angeles, CA (US)

(21) Appl. No.: 17/160,650

(22) Filed: Jan. 28, 2021

Related U.S. Application Data
(60) Provisional application No. 63/094,132, filed on Oct. 20, 2020.

(51) Int. Cl. A63F 13/212; G06F 3/03; A63F 13/23; A63F 13/22; A63F 13/428; A63F 13/44; A43B 3/00; A43B 13/14

(52) U.S. Cl. CPC A63F 13/212; G06F 3/03; A63F 13/23; A63F 13/22; A63F 13/211; A63F 13/44; A43B 3/0005; A43B 13/14; A63F 13/428

(57) ABSTRACT

Embodiments include a footwear device for controlling an electronic device, the footwear device including a toe portion, a heel portion, and a sole portion defined along a bottom portion of the footwear device between the toe and heel portion. The device further including one or more sensors incorporated with the sole portion and configured to detect a movement of the footwear device. The device further includes a controller configured to store a footwear action database comprising footwear actions respectively assigned to input control actions of the electronic device. receive the output signal of the sensors, identify a corresponding input control action using the footwear action database, and generate a control signal based on the input control action. The device further includes a communication module to transmit a control signal to a game controller such that the movement of the footwear device causes the input control action of the electronic device.

### CROSS-REFERENCES

This application claims the benefit of the filing date priority of U.S. Provisional App. Ser. No. 63/094,132, filed on Oct. 20, 2020, which is incorporated herein by reference in its entirety.

### BACKGROUND

Users of computing devices and/or gaming systems typically provide input to cause a control action or other such input response for programs or other computer activities being executed by the computing devices and/or gaming systems. Typical computing devices and/or gaming systems utilize input devices such as a keyboard, a mouse, a touchscreen, a track pad, a microphone, a joystick, and other such devices that enable the user to provide input into the computing devices and gaming systems. Use of such input devices generally require the user to touch or move the input device using fingers and/or hands to cause the corresponding action or control response. These devices may be damaging to the user's fingers, hands, and wrists because the movements utilized for input of the control actions are often repetitive movements that can cause damage and pain to the user's hands, fingers, and/or wrists over time. And most existing input devices and methods do not provide the user with the option to use other types of actions and/or body movements as inputs to control the computing devices and/or gaming systems. Moreover, many existing input devices are generally not convenient for users that prefer to use computing devices and/or gaming systems while standing and/or moving around. As such, most existing input devices are not capable of enabling an increased amount of physical activity or movement of the user while providing input to the computing device and/or gaming system.

Accordingly, there is still a need for an improved input device for an electronic device, such as a computing device or gaming system, that enables the user to provide different types of input control actions that correspond to certain controls of the electronic device. Additionally, there is still a need for an improved input device for a computing device, gaming system, and/or other electronic device that enables the user to engage in an increased amount of physical activity and/or movement while providing input to the electronic device.

### SUMMARY

Various embodiments of the present disclosure provides a footwear device configured to control an electronic device. The footwear device includes one or more sensors that can be positioned and placed in a bottom portion of a piece of footwear of the footwear device, such as a shoe. In certain embodiments, the sensor detects a movement of the footwear device and generates an output signal based on the movement. In various embodiments, the movement of the footwear device corresponds to one or more input control actions of the electronic device. As such, transmitting an output of the footwear device to the electronic device causes one or more input control actions of the electronic device based on the detected movement of the footwear device.

Connecting the footwear device of the present disclosure to an electronic device, such as a computing device or gaming system, enables the footwear device to be utilized as a controller or input device of the electronic device. In some embodiments, the movement of the user of the footwear device corresponds to certain input control actions of the electronic device. As a result, the footwear device of the present disclosure may dramatically improve the user experience of using a program, application, or playing a video game on the computing device or gaming system.

One example embodiment includes a footwear device for controlling an electronic device, the footwear device includes a toe portion defined at a first end of the footwear device, a heel portion defined at a second end of the footwear device opposite the first end, and a sole portion defined along a bottom portion of the footwear device and extending between the toe portion and the heel portion. The footwear device further includes one or more sensors incorporated with the sole portion, and the one or more sensors are configured to detect a movement of the footwear device and generate an output signal representing said movement. The footwear device further includes a footwear controller communicatively coupled to the one or more sensors and configured to store a footwear action database comprising a plurality of footwear actions respectively assigned to a plurality of input control actions for controlling the game play on the electronic device. The movement detected by the one or more sensors corresponds to one of the plurality of footwear actions. The footwear controller is further configured to receive the output signal of the one or more sensors, identify a corresponding input control action based on the movement represented by the output signal, using the footwear action database, and generate a control signal based on the corresponding input control action. The footwear device further includes a communication module communicatively coupled to the footwear controller, the communication module receives the control signal from the footwear controller and transmits the control signal to the electronic device, such that the movement detected by the one or more sensors causes the electronic device to execute the corresponding input control action.

Another example embodiment includes an entertainment system for controlling an electronic device including an electronic device and a footwear system communicatively coupled to the electronic device. The footwear system comprises a first footwear device configured to be worn on a first foot of a user and a second footwear device configured to be worn on a second foot of the user. Each of the first footwear device and the second footwear device comprises a sole portion defined along a bottom portion and extending between a toe portion and a heel portion of the footwear device. The footwear system further includes one or more sensors incorporated with the sole portion of each footwear device. The one or more sensors is configured to detect a movement of the footwear device and generate an output signal representing said movement of the footwear device. The footwear system further includes a footwear controller communicatively coupled to the one or more sensors and configured to store a footwear action database comprising a plurality of footwear actions respectively assigned to a plurality of input control actions for controlling the electronic device. The movement detected by the one or more sensors corresponds to one of the plurality of footwear actions. The footwear controller is further configured to receive the output signal of the one or more sensors, identify, based on the movement represented by the output signal, a corresponding input control action using the footwear action database, and generate a control signal based on the corresponding input control action. The footwear system further includes a communication module communicatively coupled to the footwear controller, and the communication module receives the control signal from the footwear controller and transmits the control signal to the electronic device, such that the movement detected by the one or more sensors causes the electronic device to execute the corresponding input control action.

Yet another example embodiment includes a method of controlling an electronic device utilizing a footwear device, the method includes detecting, using one or more sensors, a movement of the footwear device, and generating, at the one or more sensors, an output signal representing said movement of the footwear device. The method further includes receiving, at a footwear controller, the output signal from the one or more sensors, and identifying, using a footwear action database of the footwear controller, a corresponding input control action based on the output signal received from the one or more sensors the footwear action database comprising a plurality of footwear actions respectively assigned to a plurality of input control actions for controlling the electronic device. The method further including, generating, at the footwear controller, a control signal based on the corresponding input control action, and transmitting, via a communication module, the control signal to the electronic device such that the movement detected by the one or more sensors causes an execution of the input control action by the electronic device.

The appended claims define this application. The present disclosure summarizes aspects of the embodiments and should not be used to limit the claims. Other implementations are contemplated in accordance with the techniques described herein, as will be apparent to one having ordinary skill in the art upon examination of the following drawings and detailed description, and these implementations are intended to be within the scope of this application.

### BRIEF DESCRIPTION OF THE DRAWINGS

For a better understanding of the invention, reference may be made to embodiments shown in the following drawings. The components in the drawings are not necessarily to scale and related elements may be omitted to emphasize and clearly illustrate the novel features described herein. In addition, system components can be variously arranged, as known in the art. In the figures, like referenced numerals may refer to like parts throughout the different figures unless otherwise specified.

FIG. 1 illustrates a side view of an exemplary footwear device in accordance with embodiments.

FIG. 2A illustrates a schematic view of an exemplary entertainment system connecting a pair of footwear devices to a computing system using a wired connection, in accordance with embodiments.

FIG. 2B illustrates a schematic view of an exemplary entertainment system connecting a pair of footwear devices to a computing system using a wireless connection, in accordance with embodiments.

FIG. 2C illustrates a schematic view of an exemplary entertainment system connecting a pair of footwear devices to a gaming system using a wireless connection, in accordance with embodiments.

FIG. 3 illustrates a table of footwear actions of one or more footwear devices that correspond to a computing action of the entertainment systems of FIGS. 2A to 2C, in accordance with embodiments.

FIG. 4 illustrates a graphical user interface view of a footwear timing application of the entertainment systems of FIGS. 2A to 2C, in accordance with embodiments.

FIG. 5 illustrates a graphical user interface view of a footwear mapping application of the entertainment systems of FIGS. 2A to 2C, in accordance with embodiments.

FIG. 6 illustrates a graphical user interface view of a footwear mapping application of the entertainment systems of FIGS. 2A to 2C, in accordance with embodiments.

### DETAILED DESCRIPTION OF EXAMPLE EMBODIMENTS

While the footwear device of the present disclosure may be embodied in various forms, the Figures show and this Specification describes some exemplary and non-limiting embodiments of the footwear device. The present disclosure is an exemplification of the footwear device, and does not limit the device and system of the present disclosure to the specific illustrated and described embodiments. Not all of the depicted or described components may be required, and some embodiments may include additional, different, and/or fewer components. The arrangement and type of the components may vary without departing from the spirit or scope of the claims set forth herein.

Certain footwear devices described herein may include one or more sensors, such as but not limited to, an accelerometer, a gyroscope, a pressure sensor, other such sensor or combination thereof incorporated into the footwear device. The one or more sensors are configured to detect and/or monitor movement of the footwear device and generate one or more output signals based on detected movement of the footwear device. In certain embodiments described herein, the sensor is configured as an accelerometer that is incorporated into a portion of the footwear device. In certain other embodiments, the sensor is configured as a combination of an accelerometer and gyroscope that is incorporated into a portion of the footwear device. It should be appreciated that other types of sensing devices for detecting or monitoring movement may be used instead of or in addition to the accelerometer and gyroscope, such as but not limited to, a pressure sensor, proximity sensor, temperature sensor, humidity sensor, microphone, and capacitive touch sensor.

Various embodiments of the present disclosure provide a footwear system that includes a left footwear device and a right footwear device. In various embodiments, each footwear device includes one or more sensors, a footwear controller, and a communication module incorporated into a piece of footwear. The one or more sensors senses a movement of the footwear device, e.g., a vibration, an acceleration, a tilt, a tilt angle, or other such movement. Based thereon, the one or more sensors generates an output signal that comprises, for example, a voltage, capacitance, or any other sensor output value, representing the movement of the footwear device. The output signal of the one or more sensors is transmitted to the footwear controller of the respective footwear device. In various embodiments, the left footwear device includes a footwear controller that receives the output signal from the one or more sensors of the left footwear device and the right footwear device includes a footwear controller that receives the output signal from the one or more sensors of the right footwear device. As such, the footwear controllers generate a control signal for each respective footwear device based thereon that corresponds to an input control action of an external electronic device, such as an external computing device and/or external gaming system, communicatively connected to the footwear system, as described herein. In various embodiments, each footwear device of the footwear system also includes a communication module that establishes the connection between the given footwear device and the external electronic device. The communication module sends the control signal of each respective footwear device to the external electronic device to cause the corresponding input control action at said electronic device. As a result, the footwear system enables the user to utilize the left and right footwear devices as controllers or other such input device for controlling the external electronic device.

In various embodiments, the footwear system includes a timing application that enables a user to customize a timing parameter for defining one or more footwear actions (e.g., one or more toe taps, one or more heel taps, one or more simultaneous toe and heel taps, one or more side-to-side movements, one or more front-to-back movements, etc.) of the first and second footwear devices. In such cases, the user of the footwear system can access the timing application to time or calibrate certain footwear actions for a specific user of the footwear system.

In various embodiments, the footwear system also includes a footwear mapping application that enables a user to customize the one or more footwear actions of the first and second footwear devices that correspond to one or more different input control actions of the external electronic device. In various embodiments, the user accesses the footwear mapping application to map certain footwear actions of the first and second footwear devices (e.g., one or more toe taps, one or more heel taps, one or more simultaneous toe and heel taps, one or more side-to-side movements, or one or more front-to-back movements) to a corresponding keystroke or other input of the electronic device.

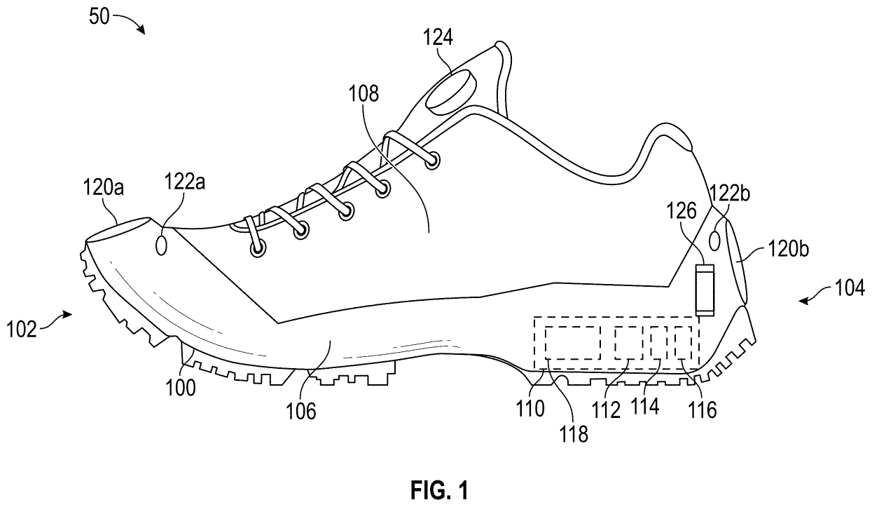

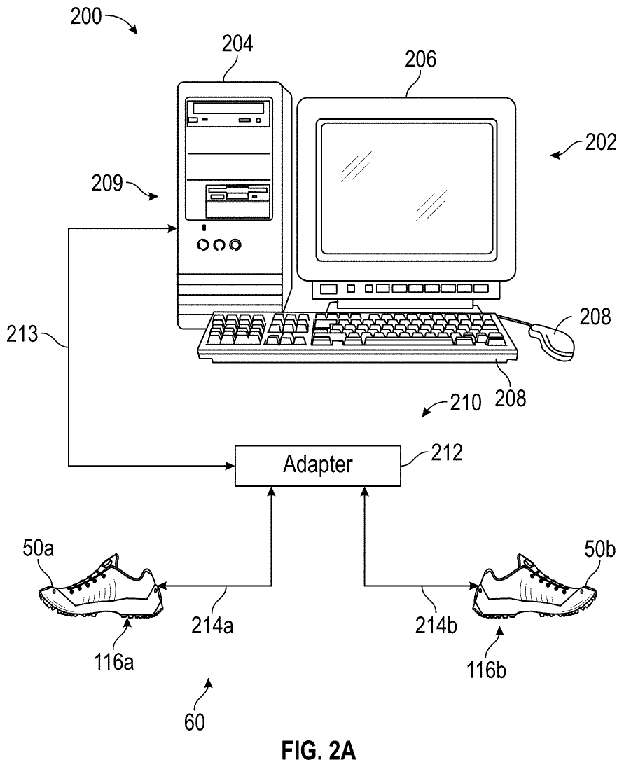

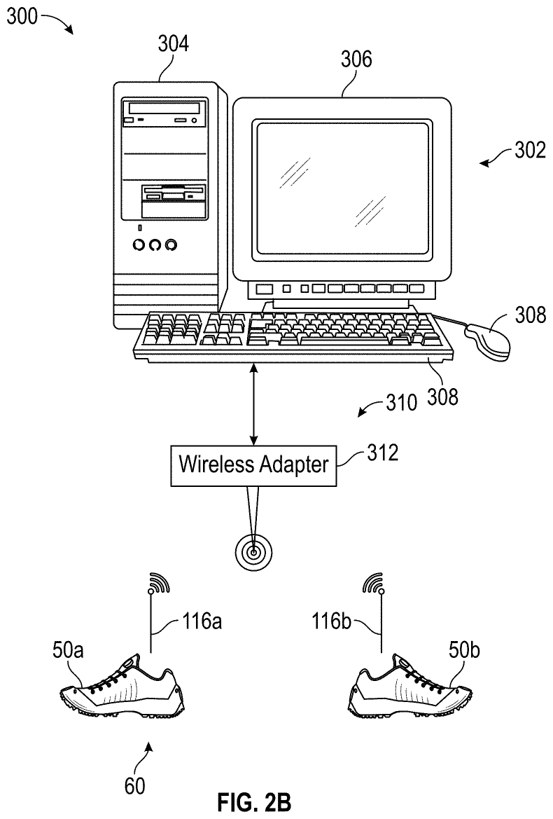

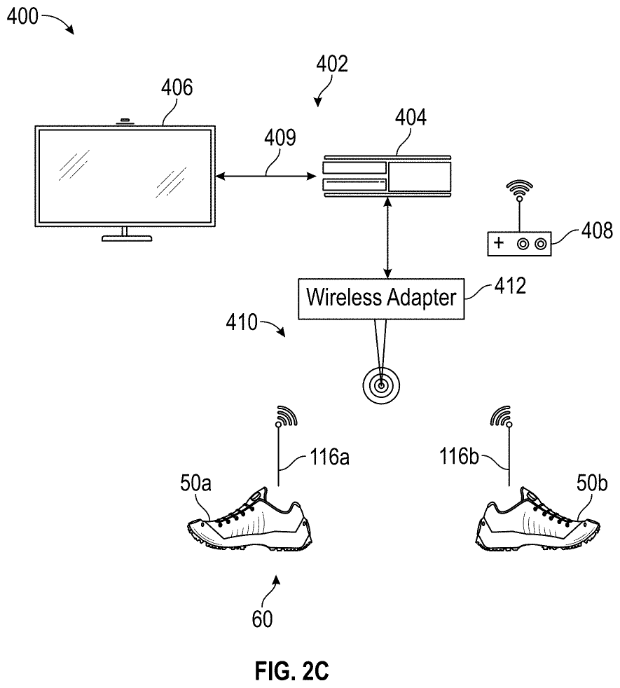

FIG. 1 illustrates a side view of an exemplary footwear device 50 (also referred to herein as “footwear” or “shoe”), in accordance with embodiments. In the illustrated example embodiment, the footwear device 50 includes an outsole 100, a midsole 106, an upper portion 108, an electronic component housing 110, one or more sensors 112, a footwear controller 114, a communication module 116, a power source 118, one or more vibrating actuators 120, one or more light-emitting diode (LED) indicators 122, one or more microphones 124, and an input/output jack 126. In various embodiments, the outsole 100, midsole 106, and upper portion 108 cooperate to form a piece of footwear for receiving and supporting a foot of a user of the footwear device 50, and portions of said piece of footwear may be configured to house the remaining, electronic components of the footwear device 50, as described herein. The piece of footwear may be a shoe, such as, e.g., a sneaker, sandal, boot, bootie, slipper, loafer, or any other item configured to be worn on a user's foot. Though not shown, the footwear device 50 may be one of a pair of footwear devices that are identical but opposite, or mirror images, of each other and are configured to form a footwear system, for example, like footwear system 60 shown in FIGS. 2A to 2C.

In the illustrated example embodiment, the outsole 100 extends between a toe portion 102 and a heel portion 104 of the footwear device 50. The outsole 100 includes an outer surface that defines a tread pattern or other such surface configured to contact the ground, floor, or other such surface that the footwear device 50 engages while being worn by a user. In the illustrated example embodiment, the midsole 106 also extends between the toe portion 102 and the heel portion 104. The outsole 100 is attached to a surface of the midsole 106 such that the outsole 100 and the midsole 106 generally run along a length of the footwear device 50.

In the illustrated example embodiment, the upper portion 108 is attached to the midsole 106 such that the midsole 106 is disposed between the outsole 100 and the upper portion 108 of the footwear device 50. The upper portion 108 defines an interior area for enclosing the user's foot while wearing and/or using the footwear device 50. In various embodiments, the upper portion 108 is fixedly attached to the midsole 106 by a stitching, an adhesive, or any combination thereof.

In various embodiments, the midsole 106 is configured with a certain thickness such that the electronic component housing 110 (shown in phantom) is disposed within at least a portion of the thickness of the midsole 106. In various embodiments, the electronic component housing 110 is configured to accommodate the one or more sensors 112 (shown in phantom), the footwear controller 114 (shown in phantom), the communication module 116 (shown in phantom), and the power source 118 (shown in phantom).

In various embodiments, the electronic component housing 110 is positioned in the midsole 106 between the toe portion 102 and the heel portion 104. In the illustrated example embodiment, the electronic component housing 110 is positioned adjacent to the heel portion 104 and contained in a cavity (not shown) defined within a portion of the midsole 106. However, it should be appreciated that the electronic component housing 110 can be alternatively positioned in the footwear device 50 such as, adjacent to the toe portion 102, at a midpoint between the toe portion 102 and the heel portion 104, or other such location of the footwear device 50.

In various embodiments, the one or more sensors 112 is configured to monitor and sense movement of the footwear device 50. For example, the one or more sensors 112 may be an electrical accelerometer, an electromechanical accelerometer, a piezoelectric accelerometer, a piezoresistive accelerometer, a capacitive accelerometer, other suitable accelerometer, a mechanical gyroscope an optical gyroscope, an electromechanical gyroscope, a gyrostat, a hemispherical resonator gyroscope, a ring laser gyroscope, other suitable gyroscope, a piezoresistive pressure sensor, a capacitive pressure sensor, an electromagnetic pressure sensor, an optical pressure sensor, or other suitable pressure sensor. As such, the one or more sensors 112 can be utilized alone or in combination, to measure movement, pressure and/or acceleration forces acting on the footwear device 50 such as, e.g., a tap, a vibration, shock, side-to-side movement, front-to-back movement, angular movement, tilt angle, or other type of movement of the footwear device 50. Moreover, the one or more sensors 112 is configured to monitor and sense movement of the footwear device 50 with respect to the ground or other surface that the user is in contact with. In various embodiments, the one or more sensors 112 senses or detects movement of the footwear device 50 and generates an output signal based on and/or representing the sensed movement of the footwear device 50. As an example, the output signal may comprise a voltage, capacitance, force, pressure, or other value measured in association with said movement.

For example, the one or more sensors 112 can detect a first movement of the footwear device 50 and a different, second movement of the footwear device 50. The first and second movements can correspond to respective footwear actions of the footwear device 50, such as, e.g., one or more taps of the toe portion 102, one or more taps of the heel portion 104, one or more simultaneous taps of both the toe portion 102 and the heel portion 104, one or more side-to-side movements, or one or more front-to-back movements. As discussed above, the one or more sensors 112 may include one or more accelerometers, gyroscopes, pressure sensors, capacitive touch sensors, or other such sensing devices that, can be used alone or in combination to sense movement, acceleration, pressure, and/or orientation of the footwear device 50.

In various embodiments, the one or more sensors 112 is communicatively connected to the footwear controller 114 such that the output signal (e.g., voltage, capacitance or other such output value) generated by the one or more sensors 112 is received by the footwear controller 114 for further processing. For example, the one or more sensors 112 generate a voltage output signal corresponding to a detected movement of the footwear device 50 such as, e.g., a toe tap, a heel tap, a simultaneous toe and heel tap, a side-to-side movement, and a front-to-back movement of the footwear device 50. More specifically, the sensor 112 outputs different voltage output signals for different types of footwear device movements For example, the footwear controller 114 utilizes the voltage output signal from the sensor 112 to distinguish between different footwear device movements (e.g., a toe tap, a heel tap, a simultaneous toe and heel tap, a side-to-side movement and a front to back movement). That is, the sensor 112 generates a different voltage output signal for each of the different footwear device movements and the footwear controller 114 utilizes the different voltage output signal to distinguish between a toe tap, a heel tap, a simultaneous toe and heel tap, a side-to-side movement and a front-to-back movement of the footwear device 50.

In such cases, the footwear controller 114 receives the voltage output signal and determines a control signal based on the voltage output signal. For example, for a single toe tap movement, the sensor 112 generates a voltage signal profile over a certain amount of time that the footwear controller 114 associates with said single toe tap movement of the footwear device 50. While, for a single heel tap movement, the sensor 112 generates a different voltage signal profile over a certain amount of time that the footwear controller associates with said single heel tap movement of the footwear device 50. In another example, for a double tap movement, the sensor 112 generates two successive voltage signals separated by a certain amount of time that the footwear controller 114 associates with said double tap movement of the footwear device 50. In this manner, the footwear controller 114 can analyze the received voltage signal to determine a corresponding footwear action, and based thereon, can determine the corresponding control signal to be output from the footwear device 50 to an external electronic device, as described herein.

As described herein, the footwear controller 114 may generate different control signals depending on whether the detected movement originated in the heel portion 104 or the toe portion 102. As such, in some embodiments, the output signal received at the footwear controller 114 from the one or more sensors 112 may also include information indicating a relative location of the movement on the footwear device 50. For example, the one or more sensors 112 may be configured to measure not only movement of the footwear device 50, but also a direction or location of that movement. This location information may be included in the output signal provided to the footwear controller 114, along with the voltage value or other measurement indicating said movement. As another example, though not shown in FIG. 1, a first sensor may be located adjacent to, or within, the heel portion 104, while a second sensor may be located adjacent to, or within, the toe portion 102. In such cases, the footwear controller 114 can determine the relative location of the movement based on the identity of the sensor 112 providing the output signal. For example, the output signal may include sensor identifier (e.g., ID number) or other location data that can be used by the footwear controller 114, along with the measured voltage value(s) and timing information described above, to determine the corresponding control signal.

In various embodiments, the footwear controller 114 is configured to execute, analyze, and/or process data and information of the footwear device 50. As such, the footwear controller 114 includes a processing device (not shown), such as but not limited to, a single-core processor, a multi-core processor, a microprocessor, a microcontroller-based platform, a logic device, one or more field programmable gate arrays (FPGAs), and/or one or more application-specific integrated circuits (ASICs).

In various embodiments, the footwear controller 114 also includes a memory device (not shown) communicatively connected to the processor. The memory device may be configured as a volatile memory device (e.g., SRAM, DRAM, etc.), a non-volatile memory device (e.g., flash memory, disk memory, EPROMs, EEPROMs, non-volatile solid-state memory, etc.), or any combination thereof. In various embodiments, the memory device stores one or more sets of instructions, executable code, and/or software for operating the footwear device 50. In various embodiments, the memory device of the footwear controller 114 also stores data and/or information associated with the output signals received from the one or more sensors 112. Additionally, the memory device of the footwear controller 114 stores data and other such information that is generated by the processing device and/or utilized by the footwear controller 114 during operation of the footwear device 50.

In various embodiments, the communication module 116 is communicatively coupled to the footwear controller 114 and configured to establish communication with an external electronic device (e.g., computing device 202 and/or 302 of FIGS. 2A and 2B and/or gaming device 402 of FIG. 2C). Accordingly, the communication module 116 is configured to transmit the control signals and other such information from the footwear controller 114 to the external device. The communication module 116 is also configured to receive signals and other such information transmitted from the external device. In some embodiments, the communication module 116 is configured to communicate with the external device through a wired communication connection such as, e.g., an Ethernet connection, USB connection, or other wired connection. In other embodiments, the communication module is configured to communicate with the external device through a wireless communication connection such as, e.g., a Wi-Fi connection, a Bluetooth connection, a near field communication (NFC) connection, a radio frequency identification (RFID) connection, or any other suitable wireless connection. In various embodiments, the communication module 116 is capable of communicating with the external device through the selection of one or more wired or wireless communication connections. That is, the footwear device 50 may communicate with the external device using a wired connection or a wireless connection.

In various embodiments, the power source 118 includes one or more rechargeable batteries, however other suitable power sources may be used. The power source 118 is electrically connected to, and configured to provide sufficient voltage and current to power, the one or more sensors 112, the footwear controller 114, the communication module 116, and any other electronic components of the footwear device 50.

In various embodiments, the one or more vibrating actuators 120 includes a first vibrating actuator 120a positioned in or adjacent to the toe portion 102 of the footwear device 50 and a second vibrating actuator 120b positioned in or adjacent to the heel portion 104 of the footwear device 50. In various embodiments, the first and second vibrating actuators 120a and 120b are configured as vibration generating devices, such as but not limited to, haptic transducers, resonant actuators, piezoelectric transducers, or other such devices configured to generate haptic sensations that are sensed by the user wearing the footwear device 50. For example, the first and second vibrating actuators 120a and 120b may generate haptic sensations associated with movement of the footwear device 50 detected by the one or more sensors 112. Additionally or alternatively, the first and second vibrating actuations 120a and 120b may generate haptic sensations associated with transmission of a control signal by the communication module 116 to the external electronic device, receipt of a signal by the communication module 116 from the external electronic device, or any other such action of the footwear device 50. It will be understood that while FIG. 1 shows two vibrating actuators, the footwear device may include a fewer or greater number of vibrating actuators. For example, a single vibrating actuator can be positioned underneath the foot and between the toe portion and the heel portion.

In various embodiments, the one or more LED indicators 122 includes a first LED indicator 122a positioned adjacent to the first vibrating actuator 120a in the toe portion 102 of the footwear device 50 and a second LED indicator 122b positioned adjacent to the second vibrating actuator 120b in the heel portion 104 of the footwear device 50. In various embodiments, the first and second LED indicators 122a and 122b emit visible light observed by the user of the footwear device 50. For example, the first and second LED indicators 122a and 122b may generate light (e.g., static light or pulsed light) associated with a detected movement of the footwear device. Additionally or alternatively, the first and second LED indicators 122a and 122b may generate light (e.g., static light or pulsed light) associated with the haptic sensations generated by the first and second vibrating actuators 120a and 120b. In various embodiments, the first and second LED indicators 122a and 122b can also communicate a status of the footwear device 50 such as, the footwear device 50 being connected to the external device, the footwear device 50 being powered on, the footwear device 50 being charged, or other such status of the footwear device 50. It should be appreciated that while FIG. 1 shows two LED indicators, a fewer or greater number of indicators may be included in the footwear device. For example, in certain embodiments, a single LED indicator may be included in the footwear device and configured to generate light associated with use and/or operation of the footwear device.

In various embodiments, the one or more microphones 124 are positioned in a portion of the upper portion 108 of the footwear device 50. The one or more microphones 124 are configured to detect or otherwise monitor voice signals and/or other audio sounds produced by the user of the footwear device 50. In various embodiments, the voice and/or other sounds detected by the one or more microphones 124 can be utilized by the footwear device 50. In one example, the voice signals and/or other external sounds may be detected by the one or more microphones 124 and converted into vibrations that are output by the one or more vibrating actuators 120 of the footwear device 50. In various embodiments, the footwear device 50 can cause the LED indicators 122 to pulse or blink in response to the voice signals and/or other external sounds detected by the one or more microphones 124.

In various embodiments, the input/output jack 126 is positioned in the heel portion 104 of the footwear device 50. The input/output jack 126 can be utilized by the communication module 116 for the wired connection between the footwear device 50 and the external device. For example, a first end of an Ethernet cable, Universal Serial Bus (USB) cable, or other such wired communication cable may be inserted into the input/output jack 126 and a second end of the Ethernet cable, USB cable, or other such wired communication cable is inserted into a communication port (not shown) of the external device to establish the wired communication of the footwear device 50. In some embodiments, the input/output jack 126 can additionally or alternatively deliver power to the electronic component housing 110 for charging the power source 118 of the footwear device 50. For example, a charging cable (e.g., USB cable) may be inserted into the input/output jack 126 to charge the rechargeable batteries of the power source 118. In certain embodiments, the input/output jack 126 can be utilized to connect to an external device, such as but not limited to an external RF module. As a result, a connection cable may be inserted into the input/output jack 126 and the external device such that the power source 118 can provide power to the external device.

FIGS. 2A, 2B, and 2C illustrate several exemplary use cases for the footwear device 50 in various types of entertainment systems. In each case, an entertainment system comprises a footwear system 60 that includes a first footwear device 50a (also referred to as a “left footwear device” or “left shoe”) and a second footwear device 50b (also referred to as a “right footwear device” or “right shoe”), the two footwear devices 50a and 50b being mirror images of each other to allow for left and right foot use, and each footwear device 50a, 50b including the elements discussed above with respect to the footwear device 50 of FIG. 1. As an example, each footwear device 50a, 50b may include one or more accelerometers (e.g., sensor 112 of FIG. 1), a respective footwear controller (e.g., footwear controller 114 of FIG. 1), and a respective communication module 116a, 116b for communicating with one or more other components of the entertainment system. According to embodiments, the entertainment systems shown in FIGS. 2A to 2C may differ from each other in terms of the other components included in the system and/or the manner in which the footwear system 60 is connected to said components, as described below.

Referring now to FIG. 2A, shown is a first exemplary entertainment system 200 comprising the footwear system 60 communicatively coupled to a computing device 202 using a wired connection, in accordance with embodiments. More specifically, in the illustrated example embodiment, the entertainment system 200 utilizes a wired communication system 210 to transmit data and information between the footwear system 60 and the computing device 202. For example, the wired communication system 210 enables the footwear system 60 to transmit information and data (e.g., one or more input control actions) from each of the footwear devices 50a and 50b to the computing device 202. The wired communication system 210 also enables the computing device 202 to transmit information and data to each of the footwear devices 50a and 50b.

In the illustrated embodiment, the computing device 202 includes a CPU 204, an output device 206, such as, e.g., a computer monitor or any other suitable display device, communicatively coupled to the CPU 204, and one or more input devices 208, such as, e.g., a keyboard, a mouse, a track pad, or a touchscreen communicatively coupled to the CPU 204. In various embodiments, the CPU 204 includes a wired communication module (not shown) and an input/output jack 209 for forming the wired communication connection (e.g., Ethernet or USB connection) between the computing device 202 and the wired communication system 210. The computing device 202 may be a personal computer, a laptop computer, a tablet computer, a server computer, a smartphone, a handheld gaming device, a handheld media device, or any other portable computing device, or any other suitable electronic device.

In the illustrated embodiment, the entertainment system 200 utilizes the wired communication system 210 to communicatively couple the first footwear device 50a and the second footwear device 50b to the computing device 202. More specifically, the wired communication system 210 includes a wired communication adapter 212, a communication input/output cable 213 communicatively coupled to the wired communication adapter 212 and the CPU 204, a first footwear input/output cable 214a communicatively coupled to the communication module 116a of the first footwear device 50a and the wired communication adapter 212, and a second footwear input/output cable 214b communicatively coupled to the communication module 116b of the second footwear device 50b and the wired communication adapter 212. In various embodiments, the wired communication adapter 212 may be a cable splitter or other hardware device capable of connecting the two footwear devices 50a and 50b to the computing device 202. In the illustrated embodiment, the wired communication adapter 212 is a separate device communicatively coupled to the CPU 204, the first footwear device 50a, and the second footwear device 50b. In an alternative embodiment, the wired communication adapter is incorporated into the CPU of the computing device. As such, the communication module of the first footwear device and the communication module of the second footwear device are communicatively coupled directly to the wired communications adapter of the CPU of the computing device. Accordingly, the entertainment system 200 enables the footwear system 60 to transmit information and data (e.g., one or more input control actions), directly or indirectly, to the computing device 202 over the wired communication connection. The entertainment system 200 also enables the computing device 202 to transmit information and data, directly or indirectly, to the footwear system 60 over the wired communication connection.

Referring now to FIG. 2B, shown is a second exemplary entertainment system 300 comprising the footwear system 60 communicatively coupled to a computing device 302 using a wireless connection, in accordance with embodiments. More specifically, in the illustrated example embodiment, the entertainment system 300 utilizes a wireless communication system 310 to wirelessly transmit data and information between the footwear system 60 and the computing device 302. For example, the wireless communication system 310 enables the footwear system 60 to transmit information and data (e.g., one or more input control actions) from each of the footwear devices 50a and 50b to the computing device 302. The wireless communication system 310 also enables the computing device 302 to transmit information and data to each of the footwear devices 50a and 50b in footwear system 60.

In the illustrated embodiment, the computing device 302 includes a CPU 304, an output device 306, such as, e.g., a computer monitor or any other suitable display device, communicatively coupled to the CPU 304, and one or more input devices 308 such as, e.g., a keyboard, a mouse, a track pad, or a touchscreen communicatively coupled to the CPU 304. In various embodiments, the CPU 304 includes a wireless communication module (not shown) for forming the wireless communication connection (e.g., Wi-Fi connection, Bluetooth connection, NFC connection, RFID connection, etc.) between the computing device 302 and the wireless communication system 310. The computing device 302 may be a personal computer, a laptop computer, a tablet computer, a server computer, a smartphone, a handheld gaming device, a handheld media device, or any other portable computing device, or any other suitable electronic device.

In the illustrated embodiment, the entertainment system 300 utilizes the wireless communication system 310 to communicatively couple each of the first footwear device 50a and the second footwear device 50b to the computing device 302. More specifically, the wireless communication system 310 includes a wireless module or adapter 312 configured to use wireless communication technology, such as, e.g., Wi-Fi, Bluetooth, NFC, etc., to connect the first and second footwear devices 50a and 50b to the computing device 302. In the illustrated example embodiment, the wireless adapter 312 is a separate device communicatively coupled to the CPU 304, the first footwear device 50a, and the second footwear device 50b. That is, the wireless adapter 312 is a standalone device that transmits wireless communication between the communication module 116a of the first footwear device 50a, the communication module 116b of the second footwear device 50b, and the computing device 302. In an alternative embodiment, the wireless adapter is incorporated into the CPU of the computing device. In such an embodiment, the communication module of the first footwear device and the communication module of the second footwear device are communicatively coupled directly to the wireless adapter of the CPU of the computing device. Accordingly, the entertainment system 300 enables the footwear system 60 to wirelessly transmit information and data (e.g., one or more input control actions), directly or indirectly, to the computing device 302. The entertainment system 300 also enables the computing device 302 to wirelessly transmit information and data, directly or indirectly, to the footwear system 60.

Referring now to FIG. 2C, shown is a third exemplary entertainment system 400 comprising the footwear system 60 communicatively coupled to a gaming device 402 using a wireless connection, in accordance with embodiments. More specifically, in the illustrated example embodiment, the entertainment system 400 utilizes a wireless communication system 410 to wirelessly transmit data and information between the footwear system 60 and the gaming device 402. For example, the wireless communication system 410 enables each of the footwear devices 50a and 50b to transmit information and data (e.g., one or more input control actions) to the gaming device 402. The wireless communication system 410 also enables the gaming device 402 to transmit information and data to each of the footwear devices 50a and 50b.

In the illustrated embodiment, the gaming device 402 includes a gaming console 404, an output device 406, such as a computer monitor, television, or any other suitable display device, communicatively coupled to the gaming console 404, and one or more input devices 408, such as, e.g., a game controller, communicatively coupled to the gaming console 404. In the illustrated embodiment, the gaming console 404 is communicatively coupled to the output device 406 using a video/audio data cable 409 such as a high definition multimedia interface (HDMI) cable, or any other suitable data cable. In the illustrated example embodiment, the one or more input devices 408 are wirelessly connected to the gaming console 404 to provide input and/or control actions to the gaming console 404. While the one or more input devices 408 are shown wirelessly connected to the gaming console 404, it will be understood that in other embodiments, the gaming device may utilize a wired connection to communicatively couple one or more input devices to the gaming console. In embodiments, the gaming console 404 may be any electronic device configured to enable game play by accepting user inputs and displaying corresponding outputs on a screen communicatively coupled to the gaming console 404. Examples of gaming consoles include the Nintendo Switch®, Nintendo Wii®, Microsoft X-Box®, Sony PlayStation®, and any other gaming consoles.

In the illustrated embodiment, the entertainment system 400 utilizes the wireless communication system 410 to communicatively couple the footwear system 60 to the gaming device 402. More specifically, the wireless communication system 410 includes a wireless module or adapter 412 configured to use wireless communication technology, such as, e.g., Wi-Fi, Bluetooth, NFC, etc., to connect each of the first and second footwear devices 50a and 50b to the gaming device 402. In the illustrated example embodiment, the wireless adapter 412 is a separate device communicatively coupled to the gaming console 404, the first footwear device 50a, and the second footwear device 50b. That is, the wireless adapter 412 is a standalone device that transmits wireless communication between the communication module 116a of the first footwear device 50a, the communication module 116b of the second footwear device 50b, and the gaming device 402. In an alternative embodiment, the wireless adapter is incorporated into the gaming console of the gaming device. In such an embodiment, the communication module of the first footwear device and the communication module of the second footwear device are communicatively coupled directly to the wireless adapter of the gaming console. Accordingly, the entertainment system 400 enables the footwear system 60 to wirelessly transmit information and data (e.g., one or more input control operations), directly or indirectly, to the gaming device 402. The entertainment system 400 also enables the gaming device 402 to wirelessly transmit information and data, directly or indirectly, to the footwear system 60.

As discussed above and shown in FIGS. 1, 2A, 2B, and 2C, the footwear devices 50a and 50b of the footwear system 60 are communicatively coupled to an external electronic device (e.g., computing device 202, computing device 302, or gaming device 402) using a wired or wireless connection. In embodiments, this connection is used to configure each of the footwear devices 50a and 50b as a controller or input device for performing one or more input control actions of the external computing device.

Specifically, in various embodiments, the output signal generated by the one or more sensors 112 of the footwear system 60 based on a detected movement can be assigned to, or cause execution of, one or more input control actions of the external electronic device. Moreover, the executed input control action(s) may depend on the type of footwear action (e.g., one or more toe taps, one or more heel taps, one or more simultaneous toe and heel taps, one or more side-to-side movements, and one or more front-to-back movements) detected by the one or more sensors 112, as well as an identity of the footwear device 50a, 50b that was used to generate the footwear action. In certain embodiments, the footwear system 60 is used in place of the one or more input devices (e.g., input devices 208, 308, and 408) of the external electronic device. In certain other embodiments, the footwear system 60 is used in combination with the one or more input devices (e.g., input devices 208, 308, and 408) of the external electronic device. In either case, the footwear system 60 enables the user to input one or more control actions, for controlling game play or any other computer program being executed on the external electronic device, using one or more footwear actions, instead of simply manipulating a handheld input device.

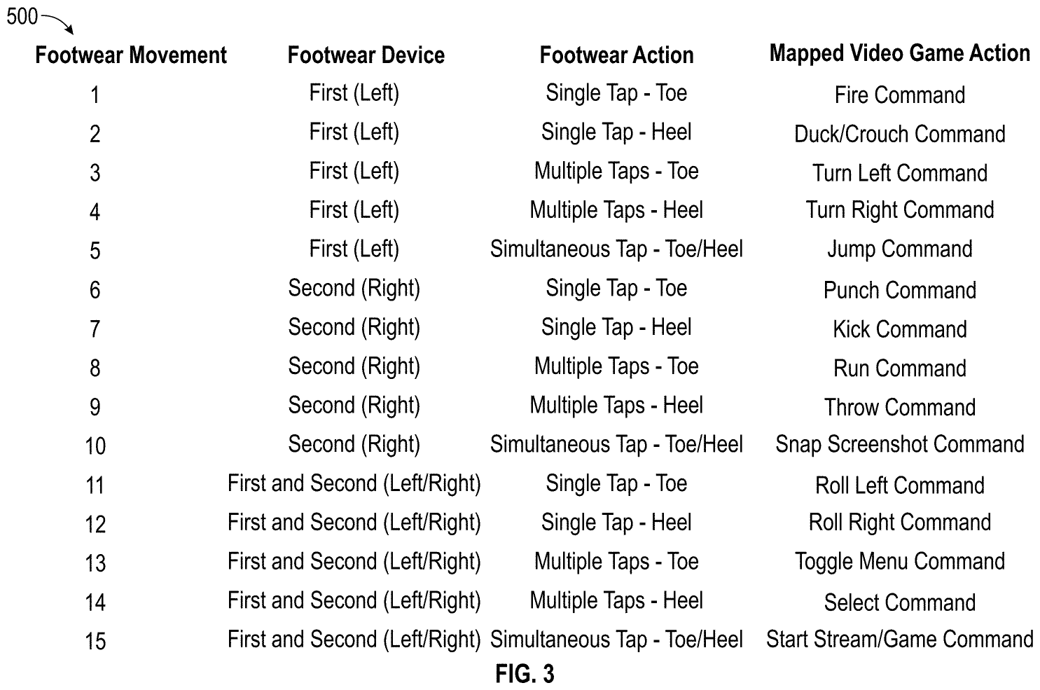

In various embodiments, the footwear system 60 comprises a footwear action database configured to store a plurality of footwear actions in association with a plurality of input control actions for controlling game play or any other computer program executed on the external electronic device. The footwear action database may comprise one or more files, lists, tables, or any other suitable model for storing said information. In one example embodiment, the footwear action database is a table configured to assign each footwear action to a respective input control action (such as, e.g., user-configurable table 500 of FIG. 3). It should be appreciated that while the user-configurable table 500 is provided as one example of footwear actions defined for input control actions of the external electronic device, other tables or suitable files can be used to define different input control actions for footwear actions to control the external electronic device.

During operation, upon detecting a movement at one of the footwear devices 50a and 50b, the one or more sensors 112 of said footwear device 50a, 50b generates a corresponding output signal and sends that output signal to the footwear controller 114 included in the corresponding footwear device 50a, 50b. The footwear controller 114 receives said output signal, determines a footwear action based on the output signal, and accesses the footwear action database to identify an input control action that is associated with the footwear action corresponding to the received output signal. The footwear controller 114 then generates a control signal based on the identified input control action, the control signal being utilized to control game play or any other computer program executed on the external electronic device (e.g., computing device 202, computing device 302, or gaming device 402).

In various embodiments, upon detecting a movement in each of the footwear devices 50a and 50b, the one or more sensors 112 of each footwear device 50a, 50b, generate a corresponding output signal and sends that output signal to the footwear controller 114 of the corresponding footwear device 50a, 50b. The footwear controller 114 of each footwear device 50a, 50b, receives the corresponding output signal, determines a footwear action based on the output signal, and accesses the footwear action database to identify the input control action that is associated with the footwear action corresponding to the received output signal. The footwear controller 114 of the corresponding footwear device 50a, 50b, then generates a control signal based on the identified input control action. More specifically, the footwear controller 114 of the footwear device 50a generates a first control signal based on a first output signal received from the one or more sensors 112 of the footwear device 50a, and the footwear controller 114 of the footwear device 50b generates a second control signal based on a second output signal received from the one or more sensors 112 of the footwear device 50b. As such, the first and second control signals being utilized to control game play or any other computer program executed on the external electronic device.

In some embodiments, the footwear action database is stored on the external electronic device such that a user of the footwear system 60 may access the footwear action database by connecting the first and second footwear devices 50a and 50b to the external electronic device. Once connected, the user can configure the footwear action database using the external electronic device, and the footwear action database can be displayed on the output device of the electronic device.

In other embodiments, the footwear action database is stored locally on the footwear system 60. For example, the footwear action database may be stored on the footwear controller 114 of each of the first and second footwear devices 50a and 50b. In such cases, the user of the footwear system 60 may access the footwear action database by connecting the footwear system 60 to the external electronic device. Once connected, the user can configure the footwear action database using the external electronic device, and said footwear action database can be displayed on the output device of the electronic device. In other embodiments, the footwear action database can be stored in a memory of, or accessible using, a mobile device (e.g., smartphone or tablet) that is communicatively coupled to the footwear system 60. In such cases, the mobile device may be used only to configure the footwear action database, as desired by the user, prior to game play on the external electronic device.

As an example, the external electronic device can execute a play of a video game. In such cases, the footwear system 60 can be used as a video game controller to perform one or more input control actions during the play of the video game. More specifically, as illustrated in the user-configurable table 500 of FIG. 3, a plurality of different footwear actions of the first and second footwear devices 50a and 50b can be respectively assigned to a plurality of different video game input control actions. During the play of the video game, the footwear controller 114 of each footwear device 50a, 50b can utilize the user-configurable table 500 to identify the input control action that corresponds to each footwear action of said footwear device 50a, 50b. That is, the user-configurable table 500 can be configured such that different movements of the first and/or second footwear devices 50a and 50b can control different movements or actions of a video game character and/or object of the video game being played by the user of the footwear system 60. In various embodiments, the same movements can correspond to different video game actions depending on which of the two footwear devices 50a and 50b is used to execute the footwear action. For example, in FIG. 3, a single tap of the toe portion of the first footwear device 50a results in a fire command video game action, while a single tap of the toe portion of the second footwear device 50b results in a punch command video game action. While the user-configurable table 500 assigns different footwear actions to different video game input control actions for play of a video game, it will be understood that alternative databases can be utilized to assign different footwear actions for different input control actions for any computer program being executed by the external electronic device.

In the illustrated example embodiment, the user-configurable table 500 is configured such that the first footwear device 50a is mapped or otherwise configured to associate the following footwear actions with video game actions: (1) a single toe tap of the first footwear device 50a causes a fire command; (2) a single heel tap of the first footwear device 50a causes a duck/crouch command; (3) multiple toe taps of the first footwear device 50a causes a turn/move left command; (4) multiple heel taps of the first footwear device 50a causes a turn/move right; and (5) a simultaneous toe and heel tap cause a jump command.

In the illustrated example, the user-configurable table 500 is configured such that the second footwear device 50b is mapped or otherwise configured to associate the following footwear actions with the following video game actions: (1) a single toe tap of the second footwear device 50b causes a punch command; (2) a single heel tap of the second footwear device 50b causes a kick command; (3) multiple toe taps of the second footwear device 50b causes a run or move forward command; (4) multiple heel taps of the second footwear device 50b causes a throw command; and (5) a simultaneous toe and heel tap of the second footwear device 50b causes a snap screenshot command.

In the illustrated example, the user-configurable table 500 is configured such that the first and second footwear devices 50a and 50b are mapped or otherwise configured to associate the following simultaneous footwear actions, or movements involving both footwear devices 50a and 50b, with the following video game actions: (1) a single simultaneous toe tap of the first and second footwear devices 50a and 50b causes a roll left command; (2) a single simultaneous heel tap of the first and second footwear devices 50a and 50b causes a roll right command; (3) multiple simultaneous toe taps of the first and second footwear devices 50a and 50b causes a toggle menu command; (4) multiple simultaneous heel taps of the first and second footwear devices 50a and 50b causes a select command; and (5) a simultaneous toe and heel tap of each footwear device 50a and 50b causes a start/pause game command.

As used herein, the term “simultaneous tap” means that the toe and heel portion of the first and second footwear devices 50a and 50b contact the ground or surface at the same time or within a threshold amount of time. It should be appreciated that while the above example provides a set of video game actions that correspond to different movements or actions of the first and second footwear devices 50a and 50b, the footwear system 60 can be configured such that alternative video game actions or computer program actions not listed in exemplary user-configurable table 500 may correspond to the various movements of the first and second footwear devices 50a and 50b described herein.

In various embodiments, it will be appreciated that certain footwear actions listed in the user-configurable table 500 can occur simultaneously. For example, the first footwear device 50a can transmit an input control action associated with a single tap of the toe portion of the first footwear device 50a and the second footwear device 50b can simultaneously transmit an input control action associated with a double tap of the heel portion of the second footwear device 50b.

In various embodiments, the user can configure the footwear system 60 with one or more timing events for customizing timing parameters that determine when the footwear actions of the first and second footwear devices 50a and 50b are recognized as input controls. More specifically, the user of the footwear system 60 can provide one or more inputs to configure a given timing parameter to define, or set, a number of taps and an amount of time between said number of taps for a particular footwear action. For example, for a multiple toe tap action of the footwear devices 50a, 50b, the user can input or otherwise set the number of taps included in the footwear action (e.g., 2 taps, 3 taps, etc.) and an amount of time within which the footwear action should be completed in order to count as an input (e.g., 0.5 seconds, 1 second, 2 seconds, etc.). Accordingly, the timing parameters are at least partially determined or otherwise defined based on the inputs provided by the user of the footwear system 60.

In various embodiments, the timing parameters or events can be configured using a footwear timing application that enables a user to provide inputs to the footwear system 60 for customizing one or more parameters that define a timing of the one or more footwear actions. The footwear timing application may include computer programming instructions or other software configured to carry out the techniques described herein. In other embodiments, the footwear timing application may be part of a timing module stored in the footwear controller 114 and comprising a combination of software and hardware (e.g., a processor and/or a memory).

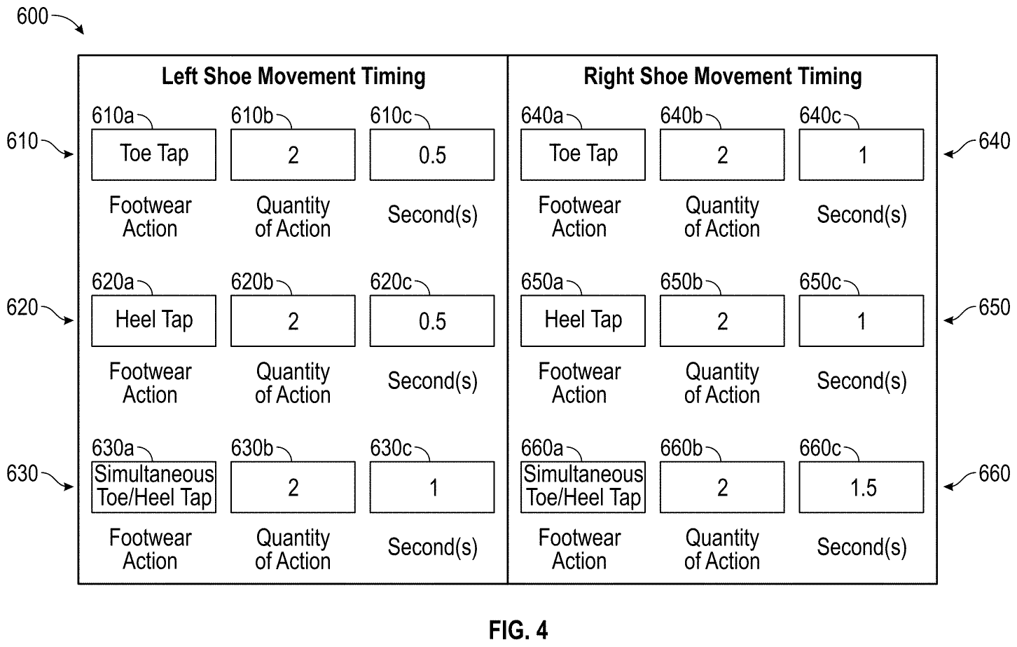

FIG. 4 illustrates an exemplary footwear timing application user interface 600 that may be presented to the user by the footwear timing application, for example, using a display device of an external electronic device or mobile device coupled to the footwear system 60. The footwear timing application user interface 600 enables the user to time or calibrate respective footwear actions of the first and second footwear devices 50a and 50b (e.g., one or more toe taps, one or more heel taps, one or more simultaneous toe and heel taps, one or more side-to-side movements, or one or more front-to-back movements).

In some embodiments, the footwear timing application is stored on the external electronic device (e.g., computing device 202, computing device 302, or gaming device 402 of FIGS. 2A to 2C) that enables the user to input one or more parameters to customize the timing parameters of the one or more footwear actions of the footwear devices 50a and 50b. and the footwear timing application at least partially determines the timing parameters based on the inputs provided by the user. For example, the footwear timing application can be stored in a memory device of the external electronic device such that the user can access the footwear timing application user interface 600 by connecting the footwear system 60 to the external electronic device. Once connected, the user can execute the footwear timing application on the electronic device, and the footwear timing application user interface 600 can be displayed on the output device of the electronic device. In such embodiments, once the timing customization is complete, the memory device of the external electronic device can store the customized timing parameters such that the user of the footwear system 60 can utilize the stored customized timing parameters during operation of the footwear system 60.

In other embodiments, the footwear timing application is stored locally on the footwear system 60 by at least one of the footwear controllers 114 of the first and second footwear device 50a, 50b that enables the user to input one or more parameters to customize the timing parameters of the one or more footwear actions of the footwear devices 50a and 50b. and the footwear timing application at least partially determines the timing parameters based on the inputs provided by the user. For example, in some cases, the footwear timing application may be stored in the memory device of the footwear controller 114 of at least one of the footwear devices 50a and 50b, such that the user can access the footwear timing application by connecting the footwear system 60 to the external electronic device. Once connected, the user can execute the footwear timing application stored in the memory device of the footwear controller using the electronic device, and the footwear timing application user interface 600 can be displayed on an output device of the external electronic device. In such embodiments, once the timing customization is complete, the memory device of the footwear controller 114 of at least one of the footwear devices 50a and 50b can store the customized timing parameters such that the user of the footwear system 60 can utilize the stored customized timing parameters during operation of the footwear system 60. In other embodiments, the footwear timing application can be stored in a memory of, or accessible using, a mobile device (e.g., smartphone or tablet) that is communicatively coupled to the footwear system 60. For example, the footwear timing application may be stored in the cloud (e.g., a cloud-computing server or other remote server), and the mobile device accesses the footwear timing application by communicating with the footwear timing application via the cloud. In such cases, the mobile device may be used only to configure the first and second footwear devices 50a and 50b, as desired by the user, prior to game play on the external electronic device.

In other embodiments, the footwear timing application is stored locally on each footwear controller 114 of the footwear devices 50a and 50b that enables the user to input one or more parameters to customize the timing parameters of the one or more footwear actions of the footwear devices 50a and 50b, and the footwear timing application at least partially determines the timing parameters based on the inputs provided by the user. For example, a first footwear timing application may be stored in the footwear controller 114 of the footwear device 50a and a second footwear timing application may be stored in the footwear controller 114 of the footwear device 50b, such that the user can access the first and second footwear timing applications by connecting the footwear system 60 to the external electronic device. Once connected, the user can execute the first and second footwear timing applications stored in the memory device of the footwear controller 114 of the corresponding footwear device 50a, 50b using the electronic device, and the footwear timing application user interface 600 can be displayed on an output device of the external electronic device. In such embodiments, the user of the footwear system 60 can utilize the first timing application to customize one or more timing parameters for the footwear device 50a and utilize the second timing application to customize one or more different timing parameters for the footwear device 50b. Once the timing customization is complete, each footwear controller 114 of the footwear device 50, 50b can store the customized timing parameters for the corresponding footwear device 50a, 50b, in the memory device of the footwear controller 114. Accordingly, the user of the footwear system 60 can utilize the stored customized timing parameters during operation of the footwear system 60. It should be appreciated that the footwear timing application can be additionally or alternatively stored at a location in the cloud (e.g., remote server), and the footwear system can access the footwear timing application by communicating with the footwear timing application via the cloud.

In various embodiments, the footwear timing application user interface 600 includes a plurality of user-selectable input parameters that enable the user to input information associated with the timing parameters of footwear actions (e.g., one or more toe taps, one or more heel taps, one or more simultaneous toe and heel taps, one or more side-to-side movements, or one or more front-to-back movements). In the illustrated example embodiment, the footwear timing application user interface 600 includes: (1) a plurality of user selectable timing parameters 610, 620, and 630 for the first footwear device 50a; and (2) a plurality of user selectable timing parameters 640, 650, and 660 for the second footwear device 50b. Accordingly, the timing parameters of the footwear actions are determined or otherwise defined based on inputs provided by the user of the footwear system 60.

In the illustrated example embodiment, a first timing parameter 610 of the footwear timing application user interface 600 includes: (1) a footwear action parameter 610a; (2) an action quantity parameter 610b; and (3) an action timing parameter 610c that enables the user to define certain timing parameters of a first footwear action (e.g., toe/heel tap) of the first footwear device 50a. For example, if the user inputs “Toe Tap” as the footwear action parameter 610a, “2” as the action quantity parameter 610b, and “0.5 seconds” as the action timing parameter 610c, then the footwear timing application defines 0.5 seconds as the timing for the double toe tap footwear action of the first footwear device 50a.

In the illustrated example embodiment, a second timing parameter 620 of the footwear timing application user interface 600 includes: (1) a footwear action parameter 620a; (2) an action quantity parameter 620b; and (3) an action timing parameter 620c that enables the user to define certain timing parameters of a second footwear action (e.g., toe/heel tap) of the first footwear device 50a. For example, if the user inputs “Heel Tap” as the footwear action parameter 620a, “2” as the action quantity parameter 620b, and “0.5 seconds” as the action timing parameter 620c, then the footwear timing application defines 0.5 seconds as the timing for the double heel tap footwear action of the first footwear device 50a.

In the illustrated example embodiment, a third timing parameter 630 of the footwear timing application user interface 600 includes: (1) a footwear action parameter 630a; (2) an action quantity parameter 630b; and (3) an action timing parameter 630c that enables the user to define certain timing parameters of a third footwear action (e.g., toe/heel tap) of the first footwear device 50a. For example, if the user inputs “Simultaneous Toe/Heel Tap” as the footwear action parameter 630a, “2” as the action quantity parameter 630b, and “1 second” as the action timing parameter 630c, then the footwear timing application defines 1 second as the timing for the double simultaneous toe/heel tap footwear action of the first footwear device 50a.

In the illustrated example embodiment, a fourth timing parameter 640 of the footwear timing application user interface 600 includes: (1) a footwear action parameter 640a; (2) an action quantity parameter 640b; and (3) an action timing parameter 640c that enables the user to define certain timing parameters of a first footwear action (e.g., toe/heel tap) of the second footwear device 50b. For example, if the user inputs “Toe Tap” as the footwear action parameter 640a, “2” as the action quantity parameter 640b, and “1 second” as the action timing parameter 640c, then the footwear timing application defines 1 second as the timing for the double toe tap footwear action of the second footwear device 50b.

In the illustrated example embodiment, a fifth timing parameter 650 of the footwear timing application user interface 600 includes: (1) a footwear action parameter 650a; (2) an action quantity parameter 650b; and (3) an action timing parameter 650c that enables the user to define certain timing parameters of a second footwear action (e.g., toe/heel tap) of the second footwear device 50b. For example, if the user inputs “Heel Tap” as the footwear action parameter 650a, “2” as the action quantity parameter 650b, and “1 second” as the action timing parameter 650c, then the footwear timing application defines 1 second as the timing for the double heel tap footwear action of the second footwear device 50b.

In the illustrated example embodiment, a sixth timing parameter 660 of the footwear timing application user interface 600 includes: (1) a footwear action parameter 660a; (2) an action quantity parameter 660b; and (3) an action timing parameter 660c that enables the user to define certain timing parameters of a third footwear action (e.g., toe/heel tap) of the second footwear device 50b. For example, if the user inputs “Simultaneous Toe/Heel Tap” as the footwear action parameter 660a, “2” as the action quantity parameter 660b, and “1.5 seconds” as the action timing parameter 660c, then the footwear timing application defines 1.5 seconds as the timing for the double simultaneous toe/heel tap footwear action of the second footwear device 50b.

In various embodiments, a footwear mapping application is configured to enable a user to provide inputs to the footwear system 60 for customizing the input control actions of the external electronic device that are associated with the one or more footwear actions of the first and second footwear devices 50a and 50b. The footwear mapping application may include computer programming instructions or other software configured to carry out the techniques described herein. In other embodiments, the footwear mapping application may be part of a mapping module stored in the footwear controller 114 and comprising a combination of software and hardware (e.g., a processor and/or a memory).

In some embodiments, the footwear mapping application is stored on the external electronic device (e.g., computing device 202, computing device 302, or gaming device 402 of FIGS. 2A to 2C) that enables the user to customize one or more parameters of the input control actions of the external electronic device that are associated with one or more footwear actions of the footwear devices 50a and 50b. For example, the footwear mapping application can be stored in a memory device of the external electronic device such that the user can access the mapping application user interface 700 by connecting the footwear system 60 to the external electronic device. Once connected, the user can execute the footwear mapping application on the electronic device, and the mapping application user interface 700 can be displayed on the output device of the external electronic device. In such embodiments, once the customization is complete, the memory device of the external electronic device can store the customized input control action parameters such that the user of the footwear system 60 can utilize the stored input control action parameters during operation of the footwear system 60. For example, the memory device stores the customized input control actions associated with the one or more footwear actions of the footwear devices 50a and 50b in a database (e.g., the user-configurable table 500) that can be accessed by the user during operation of the footwear system 60.

In other embodiments, the footwear mapping application is stored locally on the footwear system 60 by at least one of the footwear controllers 114 of the first and second footwear device 50a, 50b that enables the user to customize one or more parameters of the input control actions of the external electronic device that are associated with the one or more footwear actions of the first and second footwear devices 50a and 50b. For example, in some cases, the footwear mapping application may be stored in the memory device of the footwear controller 114 of at least one of the footwear devices 50a and 50b, such that the user can access the footwear mapping application by connecting the footwear system 60 to the external electronic device. Once connected, the user can execute the footwear mapping application stored in the memory device of the footwear controller using the electronic device, and the mapping application user interface 700 can be displayed on an output device of the external electronic device. In such embodiments, once the customization is complete, the memory device of the footwear controller 114 of at least one of the footwear devices 50a and 50b can store the customized input control action parameters such that the user of the footwear system 60 can utilize the stored customized input control action parameters during operation of the footwear system 60. For example, the memory device stores the customized input control actions associated with the one or more footwear actions of the footwear devices 50a and 50b in a database (e.g., the user-configurable table 500) that can be accessed by the user during operation of the footwear system 60. In other embodiments, the footwear mapping application can be stored in a memory of, or accessible using, a mobile device (e.g., smartphone or tablet) that is communicatively coupled to the footwear system 60. For example, the footwear mapping application may be stored in the cloud (e.g., a remote server), and the mobile device accesses the footwear mapping application by communicating with the footwear mapping application via the cloud. In such cases, the mobile device may be used only to configure the first and second footwear devices 50a and 50b, as desired by the user, prior to game play on the external electronic device.

In other embodiments, the footwear mapping application is stored locally on each footwear controller 114 of the footwear devices 50a and 50b that enables the user to customize one or more parameters of the input control actions of the external electronic device that are associated with the one or more footwear actions of the first and second footwear devices 50a and 50b. For example, a first footwear mapping application may be stored in the footwear controller 114 of the footwear device 50a and a second footwear mapping application may be stored in the footwear controller 114 of the footwear device 50b, such that the user can access the first and second footwear mapping applications by connecting the footwear system 60 to the external electronic device. Once connected, the user can execute the first and second footwear mapping applications stored in the memory device of the footwear controller 114 of the corresponding footwear device 50a, 50b using the electronic device, and the mapping application user interface 700 can be displayed on an output device of the external electronic device. In such embodiments, the user of the footwear system 60 can utilize the first mapping application to customize one or more input control action parameters for the footwear device 50a and utilize the second mapping application to customize one or more different input control action parameters for the footwear device 50b. Once the customization is complete, each footwear controller 114 of the footwear device 50, 50b can store the customized input control action parameters for the corresponding footwear device 50a, 50b, in the memory device of the footwear controller 114. Accordingly, the user of the footwear system 60 can utilize the stored customized input control action parameters during operation of the footwear system 60. For example, the memory device stores the customized input control actions associated with the one or more footwear actions of the footwear devices 50a and 50b in a database (e.g., the user-configurable table 500) that can be accessed by the user during operation of the footwear system 60. It should be appreciated that the customized input control actions can be additionally or alternatively stored in a database located in the cloud (e.g., a remote server), and the footwear system can access the database via the cloud.

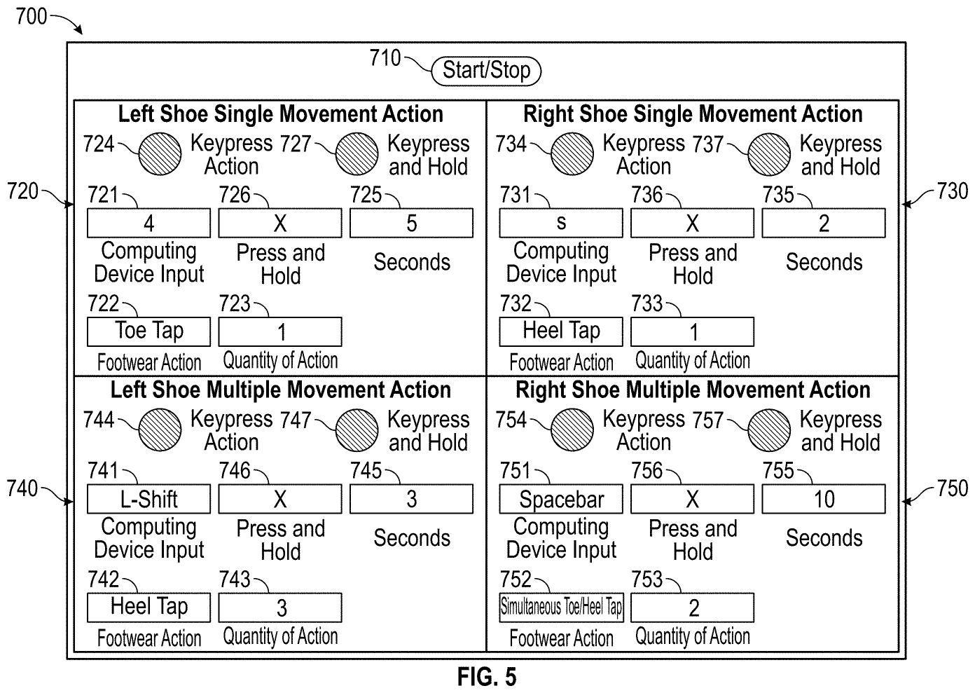

FIG. 5 illustrates an exemplary mapping application user interface 700 that may be presented to the user by the footwear mapping application, for example, using a display device of an external electronic device or mobile device coupled to the footwear system 60. The mapping application user interface 700 enables the user to map respective footwear actions of the first and second footwear devices 50a and 50b (e.g., one or more toe taps, one or more heel taps, one or more simultaneous toe and heel taps, one or more side-to-side movements, or one or more front-to-back movements) to a corresponding keystroke or other input of the electronic device.

In some embodiments, the footwear mapping application is stored on the external electronic (e.g., computing device 202, the computing device 302, or gaming device 402 of FIGS. 2A to 2C). For example, the footwear mapping application can be stored in a memory device of the external electronic device such that the user can access the mapping application user interface 700 by connecting the footwear system 60 to the electronic device. Once connected, the user can execute the footwear mapping application on the external electronic device, and the mapping application user interface 700 can be displayed on the output device of the electronic device.

In other embodiments, the footwear mapping application is stored or locally on the footwear system 60 by the footwear controller 114 of the first and second footwear devices 50a and 50b. For example, in some cases, the footwear mapping application may be stored in the memory device of the footwear controller 114 of at least one of the first and second footwear device 50a and 50b, such that the user can access the footwear mapping application by connecting the footwear system 60 to the external electronic device. Once connected, the user can execute the footwear mapping application stored in the memory device of the footwear controller 114 using the electronic device, and the mapping application user interface 700 can be displayed on an output device of the external electronic device. In other embodiments, the footwear mapping application can be stored in a memory of, or accessible using, a mobile device (e.g., smartphone or tablet) that is communicatively coupled to the footwear system 60. For example, the footwear mapping application may be stored in the cloud (e.g., a remote server), and the mobile device accesses the footwear mapping application by communicating with the footwear mapping application via the cloud. In such cases, the mobile device may be used only to configure the footwear devices 50a and 50b, as desired by the user, prior to game play on the electronic device.

In various embodiments, the mapping application user interface 700 includes a plurality of user-selectable input controls that enable the user to input information associated with mapping a footwear action to a keypress or control action of the electronic device. In the illustrated example embodiment, the mapping application user interface 700 includes: (1) a user selectable start/stop button 710; (2) a mapping control 720 for a single footwear action of the first footwear device 50a; (3) a mapping control 730 for a single footwear action of the second footwear device 50b; (4) a mapping control 740 for a multiple footwear action of the first footwear device 50a; and (5) a mapping control 750 for a multiple footwear action of the second footwear device 50b.

In the illustrated example embodiment, the user selectable start/stop button 710 enables the user to activate or deactivate the use of the footwear system 60 as an input device of the electronic device to which the user has connected the footwear system 60. More specifically, activation of the user selectable start/stop button 710 enables the user to utilize one or more footwear actions to generate an input that corresponds to a keypress or input control action of the external electronic device. Once activated, the user can use the footwear system 60 to generate inputs to the external electronic device using one or more prescribed footwear actions. On the other hand, deactivation of the user selectable start/stop button 710 disables the user's ability to use one or more footwear actions to generate an input that corresponds to a keypress or other input control action of the external electronic device. Once deactivated, the footwear devices 50a and 50b can no longer be used to generate inputs to the external electronic device using footwear actions.

In the illustrated example embodiment, the mapping control 720 for a single footwear action of the first footwear device 50a enables the user to map or otherwise define how a given single footwear action (e.g., a single toe tap, a single heel tap, or a single simultaneous toe and heel tap) corresponds to a certain keypress or other input control action of the external electronic device. In the illustrated example embodiment, the mapping control 720 includes an electronic device input parameter 721 that enables the user to define a keypress or other input control action of the electronic device that corresponds to the given single footwear action of the first footwear device 50a. For example, if the user inputs “4” as the electronic device input parameter 721, then the mapping control 720 defines the given single footwear action of the first footwear device 50a as corresponding to the “4” keypress action of the external electronic device defined in the electronic device input parameter 721.

In the illustrated example embodiment, the mapping control 720 also includes a footwear action parameter 722 that enables the user to define a certain footwear action (e.g., toe tap, heel tap, or simultaneous toe and heel tap) of the first footwear device 50a as corresponding to the keypress or other input control action of the external electronic device defined in electronic device input parameter 721. For example, as shown, if the user inputs “Toe Tap” as the footwear action parameter 722, then the mapping control 720 defines a toe tap of the first footwear device 50a as corresponding to the “4” keypress action of the external electronic device. In the illustrated example embodiment, the mapping control 720 also includes a quantity of action parameter 723 associated with the footwear action parameter 722. That is, the quantity of action parameter 723 defines how many times (e.g., 1, 2, 3, etc.) the user performs the footwear action defined by the footwear action parameter 722. For example, as shown, if the user inputs “1” as the quantity of action parameter 723, then the mapping control 720 defines a single toe tap of the first footwear device 50a as corresponding to the “4” keypress action of the electronic device.

In the illustrated example embodiment, the mapping control 720 also includes a mapping control activation/deactivation button 724 that enables the user to activate or deactivate the mapping control 720. More specifically, activation of the mapping control activation/deactivation button 724 enables the user to utilize the footwear action defined in the footwear action parameter 722 to generate an input to the external electronic device that corresponds to the keypress or other input control action defined in the electronic device input parameter 721. On the other hand, deactivation of the mapping control activation/deactivation button 724 disables the user's ability to use the footwear action defined in the footwear action parameter 722 as an input to the external electronic device that corresponds to the keypress or other input control action defined in the electronic device input parameter 721.

In the illustrated example embodiment, the mapping control 720 also includes an input hold time parameter 725 that enables the user to define a specified amount of time the keypress or other input control action associated with the electronic device input parameter 721 is held. For example, if the user inputs “5” as the input hold time parameter 725, then the mapping control 720 defines the footwear action parameter 722 as corresponding to a five second hold of the “4” keypress action defined in the electronic device input parameter 721. That is, the single toe tap of the first footwear device 50a generates an input to the electronic device that corresponds to pressing the “4” key for five seconds. The mapping control 720 also includes a press and hold parameter 726 that enables the user to associate the specified time of the input hold time parameter 725 with the electronic device input parameter 721. That is, providing an input to the press and hold parameter 726 enables the user to define the specified amount of time for the input hold time parameter 725, and not providing an input to the press and hold parameter 726 does not enable the user to define the specified amount of time for the input hold time parameter 725.

In the illustrated example embodiment, the mapping control 720 also includes a key press and hold activation/deactivation button 727 that enables the user to activate or deactivate the association of the input hold time parameter 725 with the electronic device input parameter 721. More specifically, activation of the key press and hold activation/deactivation button 727 associates the input hold time parameter 725 with the electronic device input parameter 721. On the other hand, deactivation of the key press and hold activation/deactivation button 727 does not associate the input hold time parameter 725 with the electronic device input parameter 721.

In the illustrated example embodiment, the mapping control 730 for a single footwear action of the second footwear device 50b enables the user to map or otherwise define how a given single footwear action (e.g., a single toe tap, single heel tap, or single simultaneous toe and heel tap) corresponds to a certain keypress or other input control action of the external electronic device. In the illustrated example embodiment, the mapping control 730 includes an electronic device input parameter 731 that enables the user to define a keypress or other input control action of the external electronic device that corresponds to the given single footwear action of the second footwear device 50b. For example, if the user inputs “s” as the electronic device input parameter 731, then the mapping control 730 defines that the given single footwear action of the second footwear device 50b corresponds to the “s” keypress action of the external electronic device defined in the electronic device input parameter 731.

In the illustrated example embodiment, the mapping control 730 also includes a footwear action parameter 732 that enables the user to define a certain footwear action (e.g., toe tap, heel tap, or simultaneous toe and heel tap) of the second footwear device 50b as corresponding to the keypress or other input control action of the external electronic device. For example, if the user inputs “heel tap” as the footwear action parameter 732 then the mapping control 730 defines that a heel tap of the second footwear device 50b corresponds to the “s” keypress action of the external electronic device. In the illustrated example embodiment, the mapping control 730 also includes a quantity of action parameter 733 associated with the footwear action parameter 732. That is, the quantity of action parameter 733 defines how many times (e.g., 1, 2, 3, etc.) the user performs the footwear action. For example, if the user inputs the number “1” as the quantity of action parameter 733, then the mapping control 730 defines that a single, or one, heel tap of the second footwear device 50b corresponds to the “s” keypress action of the external electronic device.

In the illustrated example embodiment, the mapping control 730 also includes a mapping control activation/deactivation button 734 that enables the user to activate or deactivate the mapping control 730. More specifically, activation of the mapping control activation/deactivation button 734 enables the user to utilize the footwear action defined in the footwear action parameter 732 to generate an input to the external electronic device that corresponds to the keypress or other input control action defined in the electronic device input parameter 731. On the other hand, deactivation of the mapping control activation/deactivation button 734 disables the user from utilizing the footwear action defined in the footwear action parameter 732 to generate an input to the external electronic device that corresponds to the keypress or other input control action defined in the electronic device input parameter 731.

In the illustrated example embodiment, the mapping control 730 also includes an input hold time parameter 735 that enables the user to define a specified amount of time the keypress or other input control action associated with the external input parameter 421 is held. For example, if the user inputs “2” seconds as the input hold time parameter 735, then the mapping control 730 defines the footwear action parameter 732 as corresponding to a two second hold of the “s” keypress action defined in the electronic device input parameter 731. That is, the single heel tap of the second footwear device 50b generates an input to the external electronic device that corresponds to pressing the “s” key for two seconds. The mapping control 730 also includes a press and hold parameter 736 that enables the user to associate the specified time of the input hold time parameter 735 with the electronic device input parameter 731. That is, providing an input to the press and hold parameter 736 enables the user to define the specified amount of time for the input hold time parameter 735, and not providing an input to the press and hold parameter 736 does not enable the user to define the specified amount of time for the input hold time parameter 735.

In the illustrated example embodiment, the mapping control 730 also includes a key press and hold activation/deactivation button 737 that enables the user to activate or deactivate the association of the input hold time parameter 735 with the electronic device input parameter 731. More specifically, activation of the key press and hold activation/deactivation button 737 associates the input hold time parameter 735 with the electronic device input parameter 731. On the other hand, deactivation of the key press and hold activation/deactivation button 737 does not associate the input hold time parameter 735 with the electronic device input parameter 731.

In the illustrated example embodiment, the mapping control 740 for a multiple footwear action of the first footwear device 50a enables the user to map or otherwise define how a multiple footwear action (e.g., multiple toe taps, multiple heel taps, or multiple simultaneous toe and heel taps) corresponds to a certain keypress or other input control action of the external electronic device. In the illustrated example embodiment, the mapping control 740 includes an electronic device input parameter 741 that enables the user to define a keypress or other input control action of the external electronic device as corresponding to the multiple footwear action of the first footwear device 50a. For example, if the user inputs “LShift” as the electronic device input parameter 741, then the mapping control 740 defines the multiple footwear action of the first footwear device 50a as corresponding to the “LShift” keypress action of the electronic device defined in the electronic device input parameter 741.

In the illustrated example embodiment, the mapping control 740 also includes a footwear action parameter 742 that enables the user to define a certain footwear action (e.g., toe tap, heel tap, or simultaneous toe and heel tap) of the first footwear device 50a that corresponds to the keypress or other input control action of the external electronic device. For example, if the user inputs “heel tap” as the footwear action parameter 742, then the mapping control 740 defines a multiple heel tap action of the first footwear device 50a as corresponding to the “LShift” keypress action of the external electronic device. In the illustrated example embodiment, the mapping control 470 also includes a quantity of action parameter 743 associated with the footwear action parameter 742. That is, the quantity of action parameter 743 defines how many times (e.g., 1, 2, 3, etc.) the user must perform the footwear action in order to be recognized as an input. For example, if the user inputs “3” as the quantity of action parameter 743, then the mapping control 740 defines three heel taps of the first footwear device 50a as corresponding to the “LShift” keypress action of the external electronic device.

In the illustrated example embodiment, the mapping control 740 also includes a mapping control activation/deactivation button 744 that enables the user to activate or deactivate the mapping control 740. More specifically, activation of the mapping control activation/deactivation button 744 enables the user to utilize the footwear action defined in the footwear action parameter 742 to generate an input to the external electronic device that corresponds to the keypress or other input control action defined in the electronic device input parameter 741. On the other hand, deactivation of the mapping control activation/deactivation button 744 disables the user from utilizing the footwear action movement defined in the footwear action parameter 742 to generate an input to the external electronic device that corresponds to the keypress or other input control action defined in the electronic device input parameter 741.

In the illustrated example embodiment, the mapping control 740 also includes an input hold time parameter 745 that enables the user to define a specified amount of hold time for keypress or other input control action associated with the electronic device input parameter 741. For example, if the user inputs “3” as the input hold time parameter 745, then the mapping control 740 defines the footwear action parameter 742 as corresponding to a three second hold of the “LShift” keypress action defined in the electronic device input parameter 741. That is, as shown, a triple heel tap of the first footwear device 50a generates an input to the external electronic device that corresponds to pressing the “LShift” key for three seconds. The mapping control 740 also includes a press and hold parameter 746 that enables the user to associate the specified time of the input hold time parameter 745 with the electronic device input parameter 741. That is, providing an input to the press and hold parameter 746 enables the user to define the specified amount of time for the input hold time parameter 745, and not providing an input to the press and hold parameter 746 does not enable the user to define the specified amount of time for the input hold time parameter 745.

In the illustrated example embodiment, the mapping control 740 also includes a key press and hold activation/deactivation button 747 that enables the user to activate or deactivate the association of the input hold time parameter 745 with the electronic device input parameter 741. More specifically, activation of the key press and hold activation/deactivation button 747 associates the input hold time parameter 745 with the electronic device input parameter 741. On the other hand, deactivation of the key press and hold activation/deactivation button 747 does not associate the input hold time parameter 745 with the electronic device input parameter 741.

In the illustrated example embodiment, the mapping control 750 for a multiple footwear action of the second footwear device 50b enables the user to map or otherwise define how a multiple footwear action (e.g., multiple toe taps, multiple heel taps, or multiple simultaneous toe and heel taps) corresponds to a certain keypress or other input control action of the external electronic device. In the illustrated example embodiment, the mapping control 750 includes an electronic device input parameter 751 that enables the user to define a keypress or other input control action of the external electronic device that corresponds to the multiple footwear action of the second footwear device 50b. For example, if the user inputs “SPACEBAR” as the electronic device input parameter 751, then the mapping control 750 defines the multiple footwear action of the second footwear device 50b as corresponding to the “SPACEBAR” keypress action of the external electronic device defined in the electronic device input parameter 751.

In the illustrated example embodiment, the mapping control 750 also includes a footwear action parameter 752 that enables the user to define a certain footwear action (e.g., toe tap, heel tap, or simultaneous toe and heel tap) of the second footwear device 50b as corresponding to the keypress or other input control action of the external electronic device. For example, if the user inputs “simultaneous toe/heel tap” as the footwear action parameter 752, then the mapping control 750 defines a multiple simultaneous toe and heel tap action of the second footwear device 50b as corresponding to the “SPACEBAR” keypress action of the external electronic device. In the illustrated example embodiment, the mapping control 750 also includes a quantity of action parameter 473 associated with the footwear action parameter 752. That is, the quantity of action parameter 753 defines how many times (e.g., 1, 2, 3, etc.) the user must perform the footwear action in order to be recognized as an input. For example, if the user inputs “2” as the quantity of action parameter 753, then the mapping control 750 defines two simultaneous toe and heel taps of the second footwear device 50b as corresponding to the “SPACEBAR” keypress action of the external electronic device.

In the illustrated example embodiment, the mapping control 750 also includes a mapping control activation/deactivation button 754 that enables the user to activate or deactivate the mapping control 750. More specifically, activation of the mapping control activation/deactivation button 754 enables the user to utilize the footwear action defined in the footwear action parameter 752 to generate an input to the external electronic device that corresponds to the keypress or other input control action defined in the electronic device input parameter 751. On the other hand, deactivation of the mapping control activation/deactivation button 754 disables the user from utilizing the footwear action defined in the footwear action parameter 752 to generate an input to the external electronic device that corresponds to the keypress or other input control action defined in the electronic device input parameter 751.

In the illustrated example embodiment, the mapping control 750 also includes an input hold time parameter 755 that enables the user to define a specified amount of time the keypress or other input control action associated with the electronic device input parameter 751 is held. For example, if the user inputs “10” as the input hold time parameter 755, then the mapping control 750 defines the footwear action parameter 752 as corresponding to a 10 second hold of the “SPACEBAR” keypress action defined in the electronic device input parameter 751. That is, the double simultaneous toe and heel tap of the second footwear device 50b generates an input to the external electronic device that corresponds to pressing the “SPACEBAR” key for ten seconds. The mapping control 750 also includes a press and hold parameter 756 that enables the user to associate the specified time of the input hold time parameter 755 with the electronic device input parameter 751. That is, providing an input to the press and hold parameter 756 enables the user to define the specified amount of time for the input hold time parameter 755, and not providing an input to the press and hold parameter 756 does not enable the user to define the specified amount of time for the input hold time parameter 755.

In the illustrated example embodiment, the mapping control 750 also includes a key press and hold activation/deactivation button 757 that enables the user to activate or deactivate the association of the input hold time parameter 755 with the electronic device input parameter 751. More specifically, activation of the key press and hold activation/deactivation button 757 associates the input hold time parameter 755 with the electronic device input parameter 751. On the other hand, deactivation of the key press and hold activation/deactivation button 757 does not associate the input hold time parameter 755 with the electronic device input parameter 751.

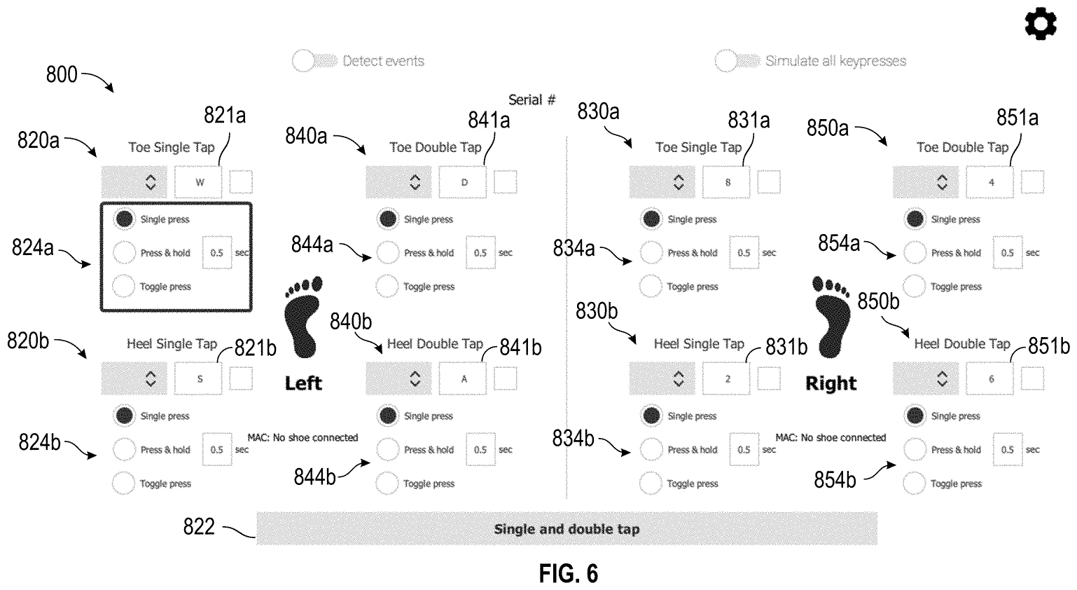

FIG. 6 illustrates another exemplary mapping application user interface 800 that may be presented to the user by the footwear mapping application, for example, using a display device of an external electronic device or mobile device coupled to the footwear system 60. The mapping application user interface 800 enables the user to map respective footwear actions of the first and second footwear devices 50a and 50b (e.g., one or more toe taps, one or more heel taps, one or more simultaneous toe and heel taps, one or more side-to-side movements, or one or more front-to-back movements) to a corresponding keystroke or other input of the electronic device.

In various embodiments, the mapping application user interface 800 includes a plurality of user-selectable input controls that enable the user to input information associated with mapping a footwear action to a keypress or control action of the electronic device. In the illustrated example embodiment, the mapping application user interface 800 includes: (1) mapping controls 820a and 820b for single footwear actions of the first footwear device 50a; (2) mapping controls 830a and 830b for single footwear actions of the second footwear device 50b; (3) mapping controls 840a and 840b for multiple footwear actions of the first footwear device 50a; and (4) mapping controls 850a and 850b for multiple footwear actions of the second footwear device 50b.

In the illustrated example embodiment, the mapping application user interface 800 further includes a footwear action parameter 822 that enables the user to define the type(s) of footwear actions that are detectable as inputs by each footwear device 50a, 50b. For example, the footwear action parameter 822 may be a drop-down menu or other interface that enables the user to input or select one of a plurality of footwear action values, such as, but not limited to, single tap, single and double tap, two or more taps, single and two or more taps, single simultaneous tap, two or more simultaneous taps, and any combination thereof or other such footwear action values. In addition, the value selected for the footwear action parameter 822 may determine which mapping controls are displayed, or active, on the mapping application user interface 800. For example, if the user inputs or selects “Single and double tap” for the footwear action parameter 822, as shown in FIG. 6, then any single toe and/or heel tap or double toe and/or heel tap detected by the footwear devices 50a and 50b may be treated as an input, and the mapping application user interface 800 may be configured to display mapping controls for single and double toe and/or heel taps of each footwear device 50a, 50b. As another example, if the user inputs or selects “Single and double simultaneous tap” for the footwear action parameter 822, then any single or double simultaneous toe and/or heel taps detected by the footwear devices 50a and 50b may be treated as an input, and the mapping application user interface 800 may be configured to display mapping controls for single and double simultaneous toe and/or heel taps of each footwear device 50a, 50b. It should be appreciated that the footwear action parameter 822 may list other types of footwear actions in addition to, or instead of, those described herein (e.g., toe taps, heel taps, or simultaneous toe and heel taps, etc.), and the mapping application user interface 800 may display other mapping controls in accordance with the selected footwear action type.

As shown in FIG. 6, when the “Single and double tap” value is selected for the footwear action parameter 822, mapping controls 820a and 820b respectively enable the user to map a keystroke or other input of the electronic device to single toe and heel taps of the footwear device 50a, and mapping controls 840a and 840b respectively enable the user to map a keystroke or other input of the electronic device to double toe and heel taps of the footwear device 50a. Likewise, mapping controls 830a and 830b respectively enable the user to map a keystroke or other input of the electronic device to single toe and heel taps of the footwear device 50b, and mapping controls 850a and 850b respectively enable the user to map a keystroke or other input of the electronic device to double toe and heel taps of the footwear device 50b. More specifically, the mapping controls 820a 820b, 840a, and 840b for the first footwear device 50a enable the user to map or otherwise define how each footwear action (e.g., a single toe or heel tap, a double toe or heel tap) corresponds to a certain keypress or other input control action of the external electronic device. As shown, the mapping controls 820a, 820b, 840a, and 840b respectively include electronic device input parameters 821a, 821b, 841a, and 841b that enable the user to define a certain keypress or other input control action of the electronic device as corresponding to the given single footwear action of the first footwear device 50a. Likewise, the mapping controls 830a, 830b, 850a, and 850b respectively include electronic device input parameters 831a, 831b, 851a, and 851b that enable the user to define a certain keypress or other input control action of the electronic device as corresponding to the given single footwear action of the second footwear device 50b.

For example, in the illustrated embodiment, for the first footwear device 50a the user has selected or input “w” as the electronic device input parameter 821a. In response, the mapping control 820a defines the single toe tap of the first footwear device 50a as corresponding to a “w” keypress action of the external electronic device. In addition, the user has selected or input “s” as the electronic device input parameter 821b, and in response, the mapping control 820b defines the single heel tap of the first footwear device 50a as corresponding to an “s” keypress action of the external electronic device. Also, the user has selected or input “D” as the electronic device input parameter 841a, and in response, the mapping control 840a defines the double toe tap of the first footwear device 50a as corresponding to a “D” keypress action of the external electronic device. Moreover, the user has selected or input “A” as the electronic device input parameter 841b, and in response, the mapping control 840b defines the double heel tap of the first footwear device 50a as corresponding to an “A” keypress action of the external electronic device.

As another example from the illustrated embodiment, for the second footwear device 50b the user has selected or input “8” as the electronic device input parameter 831a. In response, the mapping control 830a defines the single toe tap of the second footwear device 50b as corresponding to an “8” keypress action of the external electronic device. In addition, the user has selected or input “2” as the electronic device input parameter 831b, and in response, the mapping control 830b defines the single heel tap of the second footwear device 50b as corresponding to an “8” keypress action of the external electronic device. Also, the user has selected or input “4” as the electronic device input parameter 851a, and in response, the mapping control 850a defines the double toe tap of the second footwear device 50b as corresponding to a “4” keypress action of the external electronic device. Moreover, the user has selected or input “6” as the electronic device input parameter 851b, and in response, the mapping control 850b defines the double heel tap of the second footwear device 50b as corresponding to a “6” keypress action of the external electronic device.

In the illustrated example, the mapping controls 820a 820b, 830a, 830b, 840a, 840b, 850a, and 850b further include keypress action parameters 824a, 824b, 834a, 834b, 844a, 844b, 854a, and 854b, respectively, that are configured to enable the user to customize the keypress or other input control action of the electronic device. As such, the keypress action parameters 824a, 824b, 834a, 834b, 844a, 844b, 854a, and 854b can include user-selectable settings for enabling such customizations, such as, e.g., a single press setting, a press and hold setting, and a toggle press setting, as shown in FIG. 6. For example, selection of the single press setting configures the corresponding electronic device input parameter as a single keypress action, selection of the press and hold setting configures the corresponding input parameter as a keypress action that may be held for a certain amount of time (e.g., 0.5 seconds), and selection of the toggle press setting configures the corresponding input parameter as a keypress action that may be held until a subsequent performance of the respective footwear action. That is, for the single press setting the footwear action executes the corresponding input parameter once, for the press and hold setting the footwear action executes the corresponding input parameter by holding the input parameter for the selected amount of time (e.g., 0.5 seconds), and for the toggle press setting the footwear action executes the corresponding input parameter by continuously providing the input parameter until the subsequent footwear action is performed. It will be appreciated that other user-selectable settings may be included in each of the keypress action parameters 824a, 824b, 834a, 834b, 844a, 844b, 854a, and 854b, in addition to, or instead of, the three settings shown in FIG. 6 and described herein.

Unless otherwise indicated, the terms “first,” “second,” “third,” and other ordinal numbers are used herein to distinguish different elements of the present devices and methods, and are not intended to supply a numerical limit. For example, reference to first and second timing parameters should not be interpreted to mean that the footwear device only has two timing parameters. A device having first and second timing parameters can also include a third, fourth, fifth, and so on, unless otherwise indicated.

The above-described embodiments, and particularly any “preferred” embodiments, are possible examples of implementations and merely set forth for a clear understanding of the principles of the invention. Many variations and modifications may be made to the above-described embodiment(s) without substantially departing from the spirit and principles of the techniques described herein. All modifications are intended to be included herein within the scope of this disclosure and protected by the following claims.

What is claimed is:

1. A footwear device for controlling an electronic device, the footwear device comprising:
a toe portion defined at a first end of the footwear device;
a heel portion defined at a second end of the footwear device opposite the first end;
a sole portion defined along a bottom portion of the footwear device and extending between the toe portion and the heel portion;
one or more sensors incorporated with the sole portion, wherein the one or more sensors is configured to detect a movement of the footwear device and generate an output signal representing said movement;
a footwear controller communicatively coupled to the one or more sensors and configured to store a footwear action database comprising a plurality of footwear actions respectively assigned to a plurality of input control actions for controlling the electronic device, wherein the movement detected by the one or more sensors corresponds to one of the plurality of footwear actions, and the footwear controller is further configured to:
receive the output signal of the one or more sensors,
identify a corresponding input control action based on the movement represented by the output signal, using the footwear action database, and
generate a control signal based on the corresponding input control action; and
a communication module communicatively coupled to the footwear controller, wherein the communication module receives the control signal from the footwear controller and transmits the control signal to the electronic device, such that the movement detected by the one or more sensors causes the electronic device to execute the corresponding input control action.

2. The footwear device of claim 1, wherein the communication module is configured to establish at least one of a wired connection and a wireless connection between the footwear device and the electronic device.

3. The footwear device of claim 1, wherein the control signal of the footwear device is utilized to control one or more game objects of a video game being played on the electronic device.

4. The footwear device of claim 1, wherein the movement detected by the one or more sensors comprises a first movement corresponding to a first footwear action of the plurality of footwear actions, and a second movement corresponding to a second footwear action of the plurality of footwear actions.

5. The footwear device of claim 4, wherein the footwear action database comprises a user-configurable table configured to respectively assign the first footwear action to a first input control action of the plurality of input control actions and the second footwear action to a second input control action of the plurality of control actions.

6. The footwear device of claim 4, wherein each of the first footwear action and the second footwear action comprises one of one or more taps of the toe portion, one or more taps of the heel portion, one or more simultaneous taps of the toe portion and the heel portion, one or more side-to-side movements, and one or more front-to-back movements.

7. The footwear device of claim 4, wherein the footwear controller further comprises a timing application configured to define a first timing parameter for the first footwear action and a second timing parameter for the second footwear action, and wherein the first timing parameter and the second timing parameter are customizable by a user of the footwear device.

8. The footwear device of claim 7, wherein the footwear controller comprises a memory device configured to store the first timing parameter and the second timing parameter as a customized setting for the user.

9. The footwear device of claim 4, wherein the footwear controller further comprises a mapping application that enables a user to customize the plurality of footwear actions assigned to the plurality of input control actions, the mapping application being configured to associate the first footwear action with a first input control action of the plurality of input control actions of the electronic device, and associate the second footwear action with a second input control action of the plurality of input control actions of the electronic device.

10. An entertainment system for controlling an electronic device, the entertainment system comprising:
an electronic device; and
a footwear system communicatively coupled to the electronic device, the footwear system comprising:
a first footwear device configured to be worn on a first foot of a user, and
a second footwear device configured to be worn on a second foot of the user, wherein each footwear device of the first footwear device and the second footwear device comprises:
a sole portion defined along a bottom portion and extending between a toe portion and a heel portion of the footwear device,
one or more sensors incorporated with the sole portion of the footwear device, wherein the one or more sensors is configured to detect a movement of the footwear device and generate an output signal representing said movement of the footwear device,
a footwear controller communicatively coupled to the one or more sensors and configured to store a footwear action database comprising a plurality of footwear actions respectively assigned to a plurality of input control actions for controlling the electronic device, wherein the movement detected by the one or more sensors corresponds to one of the plurality of footwear actions, and the footwear controller is further configured to:
receive the output signal of the one or more sensors,
identify, based on the movement represented by the output signal, a corresponding input control action using the footwear action database, and
generate a control signal based on the corresponding input control action; and
a communication module communicatively coupled to the footwear controller, wherein the communication module receives the control signal from the footwear controller and transmits the control signal to the electronic device, such that the movement detected by the one or more sensors causes the electronic device to execute the corresponding input control action.

11. The entertainment system of claim 10, wherein the communication module is configured to establish one of a wired connection and a wireless connection between the corresponding footwear device and the electronic device.

12. The entertainment system of claim 10, wherein the first footwear device generates a first control signal and the second footwear device generates a second control signal, and wherein the first and second control signals are utilized to control one or more game objects of a video game being played on the electronic device.

13. The entertainment system of claim 10, wherein the one or more sensors of the first footwear device is configured to detect a movement of the first footwear device that comprises a first footwear action and a second footwear action, wherein the one or more sensors of the second footwear device is configured to detect a movement of the second footwear device that comprises a third footwear action and a fourth footwear action.

14. The entertainment system of claim 13, wherein each of the first footwear action and the second footwear action comprises one of one or more taps of the toe portion, one or more taps of the heel portion, one or more simultaneous tap of the toe portion and the heel portion, one or more side-to-side movements, and one or more front-to-back movements of the first footwear device, and wherein each of the third footwear action and the fourth footwear action comprises one of one or more taps of the toe portion, one or more taps of the heel portion, one or more simultaneous taps of the toe portion and the heel portion, one or more side-to-side movements, and one or more front-to-back movements of the second footwear device.

15. The entertainment system of claim 13, wherein the footwear action database comprises a user-configurable table configured to respectively assign the first footwear action to a first input control action of the plurality of input control actions, the second footwear action to a second input control action of the plurality of control actions, the third footwear action to a third input control action of the plurality of control actions, and the fourth footwear action to a fourth input control action of the plurality of control actions.

16. The entertainment system of claim 13, wherein the footwear controller of the first footwear device further comprises a first timing application configured to define a first timing parameter for the first footwear action and a second timing parameter for the second footwear action, and wherein the footwear controller of the second footwear device further comprises a second timing application configured to define a third timing parameter for the third footwear action and a fourth timing parameter for the fourth footwear action, and wherein each of the first timing parameter, the second timing parameter, the third timing parameter, and the fourth timing parameter are customizable for a user of the footwear system.

17. The entertainment system of claim 16, wherein the footwear controller comprises a memory device configured to store the first timing parameter, the second timing parameter, the third timing parameter, and the fourth timing parameter as a custom setting for the user of the footwear system.

18. The entertainment system of claim 13, wherein the footwear controller further comprises a mapping application that enables a user to customize a footwear action assigned to each input control action in said footwear action database, the mapping application being configured to respectively map the first and second footwear actions of the first footwear device to first and second input control actions of the electronic device, and respectively map the third and fourth footwear actions of the second footwear device to third and fourth input control actions of the electronic device.

19. A method of controlling an electronic device utilizing a footwear device, the method comprising:
detecting, using one or more sensors, a movement of the footwear device;
generating, at the one or more sensors, an output signal representing said movement of the footwear device;
receiving, at a footwear controller, the output signal from the one or more sensors;
identifying, using a footwear action database of the footwear controller, an input control action from a plurality of input control actions based on the output signal received from the one or more sensors, the footwear action database comprising a plurality of footwear actions respectively assigned to the plurality of input control actions for controlling the electronic device;
generating, at the footwear controller, a control signal based on the input control action; and
transmitting, via a communication module, the control signal to the electronic device such that the movement detected by the one or more sensors causes an execution of the input control action by the electronic device.

20. The method of claim 19, wherein the movement detected by the one or more sensors comprises a first footwear action and a second footwear action of the footwear device, and wherein the first footwear action and the second footwear action each comprise one of one or more taps of a toe portion, one or more taps of a heel portion, one or more simultaneous taps of the toe and the heel portion, one or more side-to-side movements, and one or more front-to-back movements of the toe portion and the heel portion of the footwear device.

21. The method of claim 20, further comprising determining, using a timing application of the footwear controller, a first timing parameter for the first footwear action and a second timing parameter for the second footwear action, and wherein the first timing parameter and the second timing parameter are determined based on inputs received from a user of the footwear device.

22. The method of claim 21, further comprising storing the first timing parameter and the second timing parameter in a memory device of the footwear controller as a custom setting for the user of the footwear device.

23. The method of claim 19, further comprising mapping, via a footwear mapping application, each footwear action of the plurality of footwear actions to a respective input control action of the plurality of input control actions.
